(19) United States
(12) Patent Application Publication
(10) Pub. No.: US 2016/0264711 A1
(43) Pub. Date: Sep. 15, 2016

(54) PRODUCTION OF POLYURETHANE SYSTEMS USING POLYETHER POLYCARBONATE POLYOLS

(71) Applicant: EVONIK DEGUSSA GMBH, Essen (DE)

(72) Inventors: Michael Krebs, Dusseldorf (DE); Roland Hubel, Essen (DE)

(73) Assignee: Evonik Degussa GmbH

(21) Appl. No.: 15/010,120

(22) Filed: Jan. 29, 2016

(30) Foreign Application Priority Data
Mar. 11, 2015 (EP) 15158626.0

(51) Int. Cl. C08G 18/48; C08G 18/76; C08J 9/00; C08G 18/08

(52) U.S. Cl. CPC C08G 18/48; C08G 18/14; C08G 18/7621; C08J 9/0042; C08G 2101/0083

(57) ABSTRACT

A process for production of polyurethane systems using polyether polycarbonate polyols with use of additives comprising i) ionic surfactant A selected from those of the formula A⁻M⁺ with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation, b) ionic surfactant B selected from a quaternized ammonium compound, c) tertiary amine compound C having a molar mass of preferably at least 150 g/mol, and/or d) oxazasilinane D is described, as are correspondingly produced polyurethane systems, preferably polyurethane foams, and the use thereof.

The present invention is in the field of polyurethanes. It especially relates to polyurethane systems which are obtained using polyether polycarbonate polyol and to a process for producing such polyurethane systems.

A variety of different polyurethanes are typically prepared by the polymerization of diisocyanates, for example 4,4′-methylenebis(phenyl isocyanate), MDI for short, or tolylene 2,4-diisocyanate, TDI for short, with polyether polyols or polyester polyols. Polyether polyols can be produced, for example, by alkoxylation of polyhydroxy-functional starters. Commonly used starters are, for example, glycols, glycerol, trimethylolpropane, pentaerythritol, sorbitol or sucrose. In the production of polyurethane foams, one of the most important polyurethane systems, additional blowing agents are typically used, examples being pentane, methylene chloride, acetone or carbon dioxide. Water is usually used as chemical blowing agent, which reacts with isocyanate to give polyurea with elimination of carbon dioxide. Typically, the polyurethane foam is stabilized using surface-active substances, especially silicone surfactants.

Polyurethane foams have outstanding mechanical and physical properties and so are used in a very wide variety of fields. The automotive and furniture industries are a particularly important market for various PU foams, such as conventional flexible foams based on ether and ester polyols, cold-cure foams (frequently also referred to as HR foams), rigid foams, integral foams and microcellular foams and also foams with properties between these classifications, for example semi-rigid systems. For instance, rigid foams are used as inner roof liner, ester foams are used as interior door trim and also for die-cut sun visors, and cold-cure and flexible foams are used for seat systems and mattresses.

Other relevant polyurethane systems are, for example, polyurethane coatings, polyurethane adhesives, polyurethane sealants or polyurethane elastomers.

There is a fundamental demand on the market for alternatives to conventional polyols for polyurethane systems, whether for environmental or economic reasons.

Thus, for example, in the production of flexible polyurethane foams, polyether polyols are used for the most part as polyol component. As is well known, polyether polyols can be prepared by means of addition of alkylene oxides onto H-functional starter substances. The most commonly used alkylene oxides are ethylene oxide and propylene oxide.

Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO₂ as comonomer is very advantageous in environmental terms, since this reaction constitutes the conversion of a greenhouse gas to a polymer.

For this reason, in the production of polyurethane systems, there has been increasing attention in the last few years on the desire to use polyols containing carbon dioxide bound in carbonate form, especially polyether polycarbonate polyols.

However, the desired use of such polyols, especially polyether polycarbonate polyols, in the production of polyurethane systems is still associated with some problems.

For example, the components to be converted have poor miscibility because of different polarity and resultant incompatibility. Moreover, the very high viscosity of the polycarbonates to be used makes them difficult to process. The resultant polyurethane foams are unsatisfactory in technical terms, since, with regard to production, they have a prolonged rise time (see, for example, WO 2013/016331, WO 2008/058913) and relatively low height (gas yield), and the resultant foams have altered physical properties, for example elongation at break, tensile strength and hardness.

There is currently no technical teaching in the literature as to how polyurethane systems, preferably polyurethane foams, especially free-rise flexible (slabstock) polyurethane foams, can be produced in a simple manner using polyols having a significant proportion of CO₂ bound within the polyol (i.e. >1% by weight of overall CO₂ constituent bound as carbonate in the polyol, % by weight based on the overall polyol) without use of complex techniques or complex reactions, especially utilizing existing production plants, without accepting the adverse extension of rise time, reduced gas yield and altered physical properties.

Against this background, the specific problem addressed by the present invention was that of providing a simple route to such polyurethane systems, preferably polyurethane foams, especially free-rise flexible slabstock polyurethane foams, which include use of polyols having a significant proportion of CO₂ bound within the polyol (i.e. >1% by weight of overall CO₂ constituent bound as carbonate in the polyol, % by weight based on the overall polyol) and, with regard to the production, have a rise time comparable to standard polyether- or polyester polyol-based polyurethane foams.

It has now been found that, surprisingly, a route to such polyurethane systems, preferably polyurethane foams, is enabled by the use of particular additives.

The problem to be mastered is solved by the subject-matter of the invention, namely a process for producing polyurethane systems, especially polyurethane foams, by reacting one or more polyol components with one or more isocyanate components,

where
i) the polyol used contains a total of at least 1% by weight, preferably at least 5% by weight, of carbon dioxide, bound in carbonate form, and
ii) at least 10% by weight of the polyol used is in polyether polycarbonate polyol form, % by weight based in each case on the total amount of polyol used,
   in the presence of an additive, additives employed being at least one, preferably two, advantageously three and especially all of the following compounds a) to d):
a) ionic surfactant A selected from those of the formula (II)

A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
b) ionic surfactant B selected from a quaternized ammonium compound,
c) a tertiary amine compound C which is not an oxazasilinane and has a molar mass of preferably at least 150 g/mol, more preferably at least 200 g/mol, and which preferably, in a concentration of 0.5% by mass in water, lowers the static surface tension of this solution to less than 40 N/m,
d) oxazasilinane D.

The term “polyol used” encompasses the entirety of the polyol used in the process according to the invention, and so encompasses all the polyol components used, and so especially also encompasses polyol mixtures.

The term “additive” in the context of this invention especially encompasses an additive composition which may comprise any of the aforementioned compounds a) to d), two or more of these compounds a) to d) or all the compounds a) to d), where this additive composition may further also comprise further components, such as solvents in particular.

The additive for use in accordance with the invention may in principle comprise the following compounds a) to d) among those mentioned above:
a; b; c; d; i.e. just one of compounds a) to d) in each case, for example a, i.e. ionic surfactant A;
a,b; a,c; a,d; b,c; b,d; c,d; i.e. two compounds a) to d) in each case, for example a,b, i.e. ionic surfactant A and ionic surfactant B;
a,b,c; a,b,d, b,c,d, a,c,d; i.e. three compounds a) to d) in each case, for example a,b,c, i.e. ionic surfactant A and ionic surfactant B and tertiary amine compound C;
a,b,c,d, i.e. all compounds a) to d), i.e. ionic surfactant A and ionic surfactant B and tertiary amine compound C and oxazasilinane D.

Through the inventive use of additive, especially of the aforementioned additive composition, with the aid of the process according to the invention, it is possible in a surprisingly simple manner to produce polyurethane systems, preferably polyurethane foams, such as flexible polyurethane foams in particular, and especially also free-rise polyurethane foams, using polyols having a significant proportion of CO₂ bound in the polyol (i.e. >1% of total CO₂ constituent, preferably >5% of total CO₂ constituent, bound in carbonate form in the polyol, % by weight based on the overall polyol) and containing polyether polycarbonate polyols, the foam production resulting in foams having good, stable and homogeneous foam structure. It is possible here to employ the usual production plants.

The rise time in the production of the foam, the rise height and the cell fineness of the resulting foam, in the process according to the invention, are each within a range typical of the production of industrial flexible polyurethane foams based on polyether polyol. In addition, the PUR foams in the process according to the invention, in relation to physical properties such as tensile strength or elongation at break, have improved values as compared with those foams which have been produced using polyether polycarbonate polyols but without use of the additive according to the invention. In the process according to the invention, it is especially possible to make use of the commercially available polyether polycarbonate polyols.

The process according to the invention also has the advantage that the additives for use in accordance with the invention, especially additive compositions, can also be used in combination with conventional stabilizers.

The process according to the invention for production of polyurethane systems is typically affected in the presence of one or more catalysts which catalyze the isocyanate-polyol and/or isocyanate-water reactions and/or the isocyanate trimerization.

The process according to the invention, the additives or additive compositions for use in accordance with the invention and the use thereof are described in detail hereinafter with reference to advantageous embodiments. Where ranges, general formulae or compound classes are specified hereinbelow, these are intended to include not only the relevant ranges or groups of compounds explicitly mentioned but also all subranges and subgroups of compounds that may be obtained by extracting individual values (ranges) or compounds. Where documents are cited in the context of the present description, it is intended that their content shall form a full part of the disclosure content of the present invention. Unless stated otherwise, percentages are figures in per cent by weight. When average values are reported hereinbelow, the values in question are weight averages, unless stated otherwise. Unless stated otherwise, the molar mass of the compounds used was determined by gel permeation chromatography (GPC) and the structure of the compounds used was determined by NMR methods, especially by ¹³C and ²⁹Si NMR. Where chemical (empirical) formulae are used in the present invention, the specified indices may be not only absolute numbers but also average values. The indices relating to polymeric compounds are preferably average values. If measured values are reported hereinbelow, these measurements, unless stated otherwise, have been conducted under standard conditions (25° C. and 1013 mbar).

In a very particularly preferred embodiment of this invention, the additive composition for use in accordance with the invention contains 0% to 90% by weight, preferably 10% to 80% by weight, more preferably 20% to 70% by weight, based on the overall additive composition, of one or more inorganic or organic solvents, preferably selected from water, alcohols, especially polyether monools or polyether polyols, preferably consisting of H-functional starter substances onto which have been added, by means of alkoxylation, alkylene oxides (epoxides) having 2-24 carbon atoms, preferably ethylene oxide and/or propylene oxide, and which have a molecular weight of preferably 200-8000 g/mol, more preferably of 300-5000 g/mol, especially preferably of 500-1000 g/mol, and a PO content of preferably 10%-100% by weight, preferably of 50%-100% by weight, and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin.

Useful polyurethane systems in the context of this invention are especially polyurethane coatings, polyurethane adhesives, polyurethane sealants, polyurethane elastomers or polyurethane foams, and most preferred are polyurethane foams, especially free-rise flexible slabstock polyurethane foams.

It is especially preferable that the additive used in the process according to the invention is an additive composition comprising
a) at least one ionic surfactant A selected from those of the formula (II)

A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
   and/or
b) at least one ionic surfactant B selected from a quaternized ammonium compound,
   and additionally
c) at least one tertiary amine compound C which is not an oxazasilinane and has a molar mass of preferably at least 150 g/mol, more preferably at least 200 g/mol, and which preferably, in a concentration of 0.5% by mass in water, lowers the static surface tension of this solution to less than 40 N/m,
   and/or, preferably and,
d) at least one oxazasilinane D,
   where the additive composition for use in accordance with the invention advantageously comprises solvents, preferably 10% to 80% by weight, more preferably 20% to 70% by weight, of one or more inorganic or organic solvents, preferably selected from water, alcohols, especially polyether monools or polyether polyols, preferably consisting of H-functional starter substances onto which have been added, by means of alkoxylation, alkylene oxides (epoxides) having 2-24 carbon atoms, preferably ethylene oxide and/or propylene oxide, and which have a molecular weight of preferably 200-8000 g/mol, more preferably of 300-5000 g/mol, especially preferably of 500-1000 g/mol, and a PO content of preferably 10%-100% by weight, preferably of 50%-100% by weight, and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin.

Accordingly, it is possible with preference in accordance with the invention to use every single one of the following adhesive compositions mentioned comprising the components:

a, c and solvent; a, d and solvent; b, c and solvent; b, d and solvent; a, c, d and solvent; a, b, d and solvent; a, b, c and solvent; b, c, d and solvent; a, b, c, d and solvent.

In the process according to the invention, it is advantageous to use polyether polycarbonate polyols. Polyether polycarbonate polyols are known per se to those skilled in the art; they have been widely described in the specialist literature and in the patent literature and they are also widely available commercially. They preferably have a structure which can be described with the general formula (Ia).

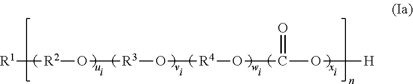

R¹ is a starter substance radical lacking the hydrogen atoms active for the alkoxylation, for example molecular residues of mono- or polyhydric alcohols, mono- or polyfunctional amines, polyhydric thiols, carboxylic acids, amino alcohols, aminocarboxylic acids, thio alcohols, hydroxy esters, polyether polyols, polyester polyols, polyester ether polyols, polyether carbonate polyols, polyethyleneimines, polyetheramines (e.g. what are called Jeffamines® from Huntsman, for example D-230, D-400, D-2000, T-403, T-3000, T-5000 or corresponding BASF products, for example Polyetheramin D230, D400, D200, T403, T5000), polytetrahydrofurans (e.g. PolyTHF® from BASF, for example PolyTHF® 250, 650S, 1000, 1000S, 1400, 1800, 2000), polytetrahydrofuranamines, polyether thiols, polyacrylate polyols, castor oil, mono- or triglycerides of castor oil, monoglycerides of fatty acids, chemically modified mono-, di- and/or triglycerides of fatty acids, and C1-C24 alkyl fatty acid esters containing an average of at least 2 OH groups per molecule.
R² is CH₂—CH₂,
R³ is CH₂—CH(CH₃),
R⁴ is CH₂—CH(R⁵), CH(R⁶)—CH(R⁶), CH₂—C(R⁶)₂, C(R⁶)₂—C(R⁶)₂,

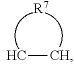

CH₂—CH—CH₂—R⁸, C₆H₆—CH—CH₂, C₆H₆—C(CH₃)—CH₂,
molecular residue of mono- or polyepoxidized fats or oils as mono-, di- and triglycerides or molecular residue of mono- or polyepoxidized fatty acids or the C₁-C₂₄-alkyl esters thereof;
R⁵ is a C₂ to C₂₄-alkyl radical or alkenyl radical which may be linear or branched;
R⁶ is a C₂ to C₂₄-alkyl radical or alkenyl radical which may be linear or branched;
R⁷ is a C₃ to C₆ alkyl radical in linear arrangement;
R⁸ is OH, Cl, OCH₃, OCH₂—CH₃, O—CH₂—CH═CH₂ or O—CH=CH₂.
In addition,
uᵢ, vᵢ, wᵢ are integers of 0-400; with at least one of the indices uᵢ, vᵢ or wᵢ≧1;
xᵢ is an integer of 1 to 100; in addition, in the general formula (Ia) for polyether polycarbonate polyols, there is neither a —C(═O)—O—C(═O)—O— bond (carbonate-carbonate bond) nor a —C(═O)—OH bond at the chain end;
n is an integer of 1 to 100, preferably of 2 to 8, especially 2 to 4;
i is an integer of i=1 to n.
In addition, for the general formula (Ia), the following relationships preferably apply:

$$\frac{1}{n} \times {\sum }_{i = 1}^{n} \frac{{x}_{i}}{{u}_{i} + {v}_{i} + {w}_{i} + {x}_{i}} = 0.01 to 0.5$$

$$\frac{1}{n} \times {\sum }_{i = 1}^{n} \frac{{u}_{i}}{{u}_{i} + {v}_{i} + {w}_{i} + {x}_{i}} = 0 to 0.7$$

$$\frac{1}{n} \times {\sum }_{i = 1}^{n} \frac{{v}_{i}}{{u}_{i} + {v}_{i} + {w}_{i} + {x}_{i}} = 0 to 0.99$$

$$\frac{1}{n} \times {\sum }_{i = 1}^{n} \frac{{w}_{i}}{{u}_{i} + {v}_{i} + {w}_{i} + {x}_{i}} = 0 to 0.7$$

The sequence of the monomer units in the individual polymer chains 1 to n is as desired, although —C(═O)—O—C(═O)—O— bonds (carbonate-carbonate bond) should not occur within the polymer chains, nor should —C(═O)—OH bonds occur at the chain end of individual polymer chains. In addition, the compositions of the n-polymer chains of the polyether polycarbonate polyol should be independent of one another. In addition, it may be the case that not all or just one of the n-polymer chains grows by means of alkoxylation during the addition.

If mixtures of starter substances are used, it is possible for different structures of polyether polycarbonate polyols of the general formula (Ia) to be present alongside one another.

If, in the formula (Ia), uᵢ, vᵢ, wᵢ, ≠0, uᵢ, vᵢ≠0 and at the same time wᵢ=0, the individual units (R²—O), (R³—O) and (R⁴—O) or (R²—O) and (R³—O), independently of (C(═O)—O) units, may be bonded to one another in the form of blocks, in strict alternation or in the form of gradients.

Preference is given to polyether carbonate polyols formed from starter substances, ethylene oxide, propylene oxide and CO₂. These can be described by the general formula (Ib)

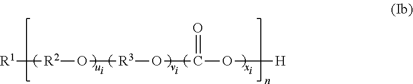

where R¹, R² and R³ have the same definition as in formula (Ia).
In addition,
uᵢ, vᵢ are integers of 0-400; with at least uᵢ or vᵢ≧1;
xᵢ is an integer of 1 to 100; in addition, in the general formula (Ib) for polyether polycarbonate polyols, there is neither a —C(═O)—O—C(═O)—O— bond (carbonate-carbonate bond) nor a —C(═O)—OH bond at the chain end;
n is an integer of 1 to 100, preferably of 2 to 8, especially 2 to 4;
i is an integer of i=1 to n.
In addition, for the general formula (Ib), the following relationships preferably apply:

$$\frac{1}{n} \times {\sum }_{i = 1}^{n} \frac{{x}_{i}}{{u}_{i} + {v}_{i} + {x}_{i}} = 0.01 to 0.5$$

$$\frac{1}{n} \times {\sum }_{i = 1}^{n} \frac{{u}_{i}}{{u}_{i} + {v}_{i} + {x}_{i}} = 0 to 0.7$$

$$\frac{1}{n} \times {\sum }_{i = 1}^{n} \frac{{v}_{i}}{{u}_{i} + {v}_{i} + {x}_{i}} = 0 to 0.99$$

The sequence of the monomer units in the individual polymer chains 1 to n is as desired, although —C(═O)—O—C(═O)—O— bonds (carbonate-carbonate bond) should not occur within the polymer chains, nor should —C(═O)—OH bonds occur at the chain end of individual polymer chains. In addition, the compositions of the n-polymer chains of the polyether polycarbonate polyol should be independent of one another. In addition, it may be the case that not all or just one of the n-polymer chains grows by means of alkoxylation during the addition.

If mixtures of starter substances are used, it is possible for different structures of polyether polycarbonate polyols of the general formula (Ib) to be present alongside one another.

If, in the formula (Ib), uᵢ, vᵢ≠0, the individual units (R²—O) and (R³—O), independently of (C(═O)—O) units, may be bonded to one another in the form of blocks, in strict alternation or in the form of gradients.

Particular preference is given to polyether carbonate polyols formed from starter substances, propylene oxide and CO₂. These can be described by the general formula (Ic)

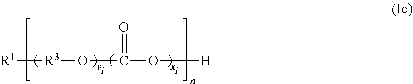

R¹ and R³ have the same definition as in formula (Ia).
In addition,
vᵢ, are integers of 4-400; with at least uᵢ or vᵢ≧1;
xᵢ is an integer of 1 to 100; in addition, in the general formula (Ic) for polyether polycarbonate polyols, there is neither a —C(═O)—O—C(═O)—O— bond (carbonate-carbonate bond) nor a —C(═O)—OH bond at the chain end;
n is an integer of 1 to 100, preferably of 2 to 8, especially 2 to 4;
i is an integer of i=1 to n.
In addition, for the general formula (Ic), the following relationships preferably apply:

$$\frac{1}{n} \times {\sum }_{i = 1}^{n} \frac{{x}_{i}}{{v}_{i} + {x}_{i}} = 0.01 to 0.5$$

$$\frac{1}{n} \times {\sum }_{i = 1}^{n} \frac{{v}_{i}}{{v}_{i} + {x}_{i}} = 0.5 to 0.99$$

The sequence of the monomer units in the individual polymer chains 1 to n is as desired, although —C(═O)—O—C(═O)—O— bonds (carbonate-carbonate bond) should not occur within the polymer chains, nor should —C(═O)—OH bonds occur at the chain end of individual polymer chains. In addition, the compositions of the n-polymer chains of the polyether polycarbonate polyol should be independent of one another. In addition, it may be the case that not all or just one of the n-polymer chains grows by means of alkoxylation during the addition.

If mixtures of starter substances are used, it is possible for different structures of polyether polycarbonate polyols of the general formula (Ic) to be present alongside one another.

The preparation of polyether polycarbonate polyols by addition of alkylene oxides and carbon dioxide onto H-functional starter substances by use of catalysts is well known. Various catalyst systems can be used here: The first generation was that of heterogeneous zinc or aluminum salts, as described, for example, in U.S. Pat. No. 3,900,424 or U.S. Pat. No. 3,953,383. In addition, mono- and binuclear metal complexes have been used successfully for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Polyether polycarbonate polyols obtainable in this way are usable with preference in the context of this invention.

In general, for preparation of the polyether polycarbonate polyols, it is possible, for example, to use alkylene oxides (epoxides) having preferably 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably, the alkylene oxides used may be ethylene oxide and/or propylene oxide, especially propylene oxide.

Suitable H-functional starter substances used may especially be compounds having hydrogen atoms active for the alkoxylation. Groups having active hydrogen atoms that are active for the alkoxylation are, for example, —OH, —NH₂ (primary amines), —NH— (secondary amines), —SH and —CO₂H, preference being given to —OH and —NH₂, particular preference to —OH. H-functional starter substances used are, for example, one or more compounds selected from the group consisting of water, mono- or polyhydric alcohols, mono- or polyfunctional amines, polyhydric thiols, carboxylic acids, amino alcohols, aminocarboxylic acids, thio alcohols, hydroxy esters, polyether polyols, polyester polyols, polyester ether polyols, polyether polycarbonate polyols, polyethyleneimines, polyetheramines (e.g. what are called Jeffamines® from Huntsman, for example D-230, D-400, D-2000, T-403, T-3000, T-5000 or corresponding BASF products, for example Polyetheramin D230, D400, D200, T403, T5000), polytetrahydrofurans (e.g. PolyTHF® from BASF, for example PolyTHF® 250, 650S, 1000, 1000S, 1400, 1800, 2000), polytetrahydrofuranamines, polyether thiols, polyacrylate polyols, castor oil, the mono- or triglyceride of castor oil, monoglycerides of fatty acids, chemically modified mono-, di- and/or triglycerides of fatty acids, and C₁-C₂₄ alkyl fatty acid esters containing an average of at least 2 OH groups per molecule. By way of example, the C₁-C₂₄ alkyl fatty acid esters containing an average of at least 2 OH groups per molecule are commercial products such as Lupranol Balance® (from BASF SE), Merginol® products (from Hobum Oleochemicals GmbH), Sovermo products (from Cognis Deutschland GmbH & Co. KG) and Soyol® TM products (from USSC Co.). Monofunctional starter compounds used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. The following monofunctional thiols may be used: ethanethiol, 1-propanethiol, 2-propanethiol, 1-butanethiol, 3-methyl-1-butanethiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentane-1,5-diol, methylpentanediols (for example 3-methylpentane-1,5-diol), hexane-1,6-diol, octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexanol, sucrose, starch, starch hydrolysates, cellulose, cellulose hydrolysates, hydroxy-functionalized fats and oils, especially castor oil), and all modification products of these aforementioned alcohols with different amounts of ε-caprolactone.

The H-functional starter substances may also be selected from the substance class of the polyether polyols, especially those having a molecular weight Mn in the range from 100 to 4000 g/mol. Preference is given to polyether polyols formed from repeat ethylene oxide and propylene oxide units, preferably having a proportion of 35% to 100% propylene oxide units, more preferably having a proportion of 50% to 100% propylene oxide units. These may be random copolymers, gradient copolymers, alternating or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex® Baygal®, PET® and polyether polyols from Bayer MaterialScience AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1 1 10, Bayfill® VPPU 0789, Baygal® K55, PET® 1004, Polyether® S 180). Further suitable homopolyethylene oxides are, for example, the Pluriol® E brands from BASF SE; suitable homopolypropylene oxides are, for example, the Pluriol® P brands from BASF SE; suitable mixed copolymers of ethylene oxide and propylene oxide are, for example, the Pluronic® PE or Pluriol® RPE brands from BASF SE. The H-functional starter substances may also be selected from the substance class of the polyester polyols, especially those having a molecular weight Mn in the range from 200 to 4500 g/mol. Polyester polyols used are at least difunctional polyesters. Preferably, polyester polyols consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of said acids and/or anhydrides. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol component used is dihydric or polyhydric polyether polyols, the result is polyester ether polyols which can likewise serve as starter substances for preparation of the polyether polycarbonate polyols. Preference is given to using polyether polyols having Mn=150 to 2000 g/mol for preparation of the polyester ether polyols.

In addition, H-functional starter substances used may, for example, be polycarbonate diols, especially those having a molecular weight Mn in the range from 150 to 4500 g/mol, preferably 500 to 2500, which are prepared, for example, by reaction of phosgene, dimethyl carbonate, diethyl carbonate or diphenyl carbonate and difunctional alcohols or polyester polyols or polyether polyols. Examples of polycarbonates can be found, for example, in EP-A 1359177. For example, the polycarbonate diols used may be the Desmophen® products from Bayer MaterialScience AG, for example Desmophen® C 1100 or Desmophen® C 2200. In a further embodiment of the invention, polyether polycarbonate polyols can be used as monofunctional starter substances. These polyether polycarbonate polyols used as monofunctional starter substances are prepared beforehand for this purpose in a separate reaction step.

The H-functional starter substances generally have a functionality (i.e. number of hydrogen atoms active for the polymerization per molecule) of 1 to 8, preferably of 2 or 3. The H-functional starter substances are used either individually or as a mixture of at least two H-functional starter substances.

Preferred H-functional starter substances are alcohols of the general formula HO—(CH₂)ₓ—OH where x is a number from 1 to 20, preferably an even number from 2 to 20. Examples of alcohols of this formula are ethylene glycol, butane-1,4-diol, hexane-1,6-diol, octane-1,8-diol, decane-1,10-diol and dodecane-1,12-diol.

Further preferred H-functional starter substances are, for example, neopentyl glycol, trimethylolpropane, glycerol, pentaerythritol, reaction products of the alcohols of the formula HO—(CH₂)ₓ—OH just mentioned with ε-caprolactone, for example reaction products of trimethylolpropane with ε-caprolactone, reaction products of glycerol with ε-caprolactone, and reaction products of pentaerythritol with ε-caprolactone. Additionally preferably, H-functional starter substances used are water, diethylene glycol, dipropylene glycol, castor oil, sorbitol and polyether polyols formed from repeat polyalkylene oxide units.

More preferably, the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol is formed from a di- or tri-H-functional starter compound and propylene oxide or a di- or tri-H-functional starter compound, propylene oxide and ethylene oxide. The polyether polyols preferably have a molecular weight Mn in the range from 62 to 4500 g/mol and a functionality of 2 to 4 and especially a molecular weight Mn in the range from 62 to 3000 g/mol and a functionality of 2 to 3.

Double metal cyanide (DMC) catalysts are known in principle from the prior art (cf., for example, U.S. Pat. No. 3,404,109, U.S. Pat. No. 3,829,505, U.S. Pat. No. 3,941,849 and U.S. Pat. No. 5,158,922). DMC catalysts, as, for example, in U.S. Pat. No. 5,470,813, EP-A 700949, EP-A 743093, EP-A 761708, WO 97/40086, WO 98/16310 and WO 00/47649, have a very high activity and enable the preparation of polyether polycarbonate polyols at very low catalyst concentrations. A typical example is the high-activity DMC catalysts which are described in EP-A 700949 and contain not only a double metal cyanide compound (e.g. zinc hexacyanocobaltate(III)) and an organic complex ligand (e.g. tert-butanol) but also a polyether having a number-average molecular weight greater than 500 g/mol.

More particularly, with regard to the polyether polycarbonate polyols usable in the context of this invention, reference may be made to the corresponding patent literature, reference being made here particularly to WO 2008/092767 A1 (BASF), WO 2012/049162A1 (Bayer MaterialScience), WO 2010/028362 A1 (Novomer), WO 2010/013948 A2 (Sk Energy Co), the content of which is hereby fully incorporated by reference. Polyether polycarbonate polyols obtainable according to the teaching of these publications are usable with preference in the context of this invention.

The polyether polycarbonate polyols usable with preference in accordance with the invention may generally have a functionality of at least 1, preferably of 2 to 8, more preferably of 2 to 6 and most preferably of 2 to 4.

According to a preferred embodiment of the invention, in the process according to the invention, polyol is used, such that at least 20% by weight, further advantageously at least 30% by weight, preferably at least 50% by weight and especially at least 75% by weight of the polyol used is in polyether polycarbonate polyol form, % by weight based in each case on the total amount of polyol used.

According to a further preferred embodiment of the invention, the polyol has a total content of carbonate groups (calculated as CO₂) of at least 1% by weight, preferably of at least 5% by weight, more preferably of at least 10% by weight and most preferably of 15% to 50% by weight.

When the polyether polycarbonate polyol used in accordance with the invention preferably has a number-average molecular weight of 500 to 20 000, preferably 500 to 5000, more preferably 750 to 4000 and most preferably 1000 to 3500, this is a further preferred embodiment of the invention. The above-cited number-average molecular weights are number-average molecular weights determined on the basis of DIN 55672-1:2007-8 by gel permeation chromatography (GPC), calibration having been effected against a polypropylene glycol standard (76-6000 g/mol).

Preferably, the polyether polycarbonate polyols for use in accordance with the invention contain 1%-50% by weight, advantageously 2%-43% by weight and more preferably 5%-20% by weight of carbon dioxide in the form of carbonate units, 0%-60% by weight and preferably 1%-50% by weight of ethylene oxide and 0%-90% by weight and preferably 1%-98% by weight of propylene oxide, % by weight based on the molecular moiety of the polyether polycarbonate polyol formed by the addition of carbon dioxide minus the starter substance.

Alkylene oxide used may accordingly, for example, be exclusively propylene oxide or else, for example, exclusively ethylene oxide. Alkylene oxide used may accordingly either be propylene oxide or ethylene oxide. Most preferably, the alkylene oxide used is exclusively propylene oxide. The polyether polycarbonate polyols for use in accordance with the invention in that case most preferably contain 2%-43% by weight of carbon dioxide in the form of carbonate units and 57%-98% by weight of propylene oxide, based on the molecular moiety of the particular polyether polycarbonate polyol formed by the reaction minus the starter substance.

The polyether polycarbonate polyol used in accordance with the invention may also take the form of a prepolymer. Prepolymers in the context of this invention are understood to mean isocyanate-modified polyol compositions. The isocyanate-modified polyol may be prepared, for example, by reaction of at least one polyol component with at least one multifunctional isocyanate, preferably with the aid of a catalyst, where the amount of isocyanate is between 0.01% (preferably 0.05%, more preferably 0.1%) and 15%, preferably 10%, more preferably 5%, of the amount of isocyanate required in theoretical terms for reaction with all the available OH groups in the polyol, and at least one polyol for preparation of the isocyanate-modified polyol is a polyether polycarbonate polyol. The isocyanate-modified polyolefin is thus a storage-stable, preferably non-separating, liquid unfoamed polyol polymer having terminal OH groups. Thus, good miscibility of the components used shall be assured.

According to a preferred embodiment, the additive composition for use in accordance with the invention contains at least one ionic surfactant B selected from a quaternized ammonium compound, and at least one oxazasilinane D. The use of these two components together results in a synergistic effect.

According to a preferred embodiment, the additive composition for use in accordance with the invention comprises at least one ionic surfactant B selected from a quaternized ammonium compound, and at least one tertiary amine compound C which is not an oxazasilinane and has a molar mass of preferably at least 150 g/mol, more preferably of at least 200 g/mol, and which preferably, in a concentration of 0.5% by mass in water, lowers the static surface tension of this solution to less than 40 N/m.

According to a further preferred embodiment, the additive composition for use in accordance with the invention comprises at least one ionic surfactant B selected from a quaternized ammonium compound, and at least one tertiary amine compound C which is not an oxazasilinane and has a molar mass of preferably at least 150 g/mol, more preferably of at least 200 g/mol, and which preferably, in a concentration of 0.5% by mass in water, lowers the static surface tension of this solution to less than 40 N/m, and at least one oxazasilinane D.

The abovementioned static surface tension was determined to DIN EN 14370 (determination of surface tensions). For this purpose, the samples were analyzed in bidistilled water solution. Solutions were calculated to 100 ml, and weighed out on an analytical balance. If foam formed on the sample, it was removed by suction with a pipette. For the measurements, a Kruss K100MK2 tensiometer was used, as was a Kruss standard plate (Pt, 19.900×0.200×10.000 mm) for the plate method or a Kruss standard ring (du Noüy) (Pt, r=9.545 mm, thickness 0.370 mm) for the ring method. For the calibration, type I bidistilled water (resistivity value: 18.2 MΩcm; TOC content<5 ppb) from Millipore Simplicity UV from Millipore and 1-octanol≧99% from Sigma-Aldrich were used.

Preferably, the surfactant B is selected from an imidazolium compound, a pyridinium compound or a compound of the formula (IIIa) to (IIIc)

NR⁹ₓR¹⁰₄₋ₓ⁺X⁻ (IIIa)

R^{1′}R^{2′}R^{3′}R^{4′}N⁺X⁻ (IIIb)

R^{1′}R^{2′}N⁺═CR^{3′}R^{4′}X⁻ (IIIc)

with x=0 to 4, preferably 1 to 3, more preferably 2 or 3, X⁻=anion, R⁹=identical or different, preferably identical, alkyl radicals having 1 to 3 carbon atoms, preferably two carbon atoms and more preferably one carbon atom,
R¹⁰=identical or different hydrocarbyl radicals optionally containing double bonds and having 5 to 30, preferably 8 to 20, carbon atoms, aryl radicals, alkylaryl radicals or alkoxylated hydrocarbyl radicals, polyether radicals of the formula (VI)

—(CH₂)_{y}—O—(C₂H₄O)ₒ—(C₃H₆O)ₚ—OH (VI)

with o and p independently being 0 to 100, preferably 0 to 50, where the sum of o+p in each case is greater than 0, and y is 2 to 4, preferably 2,

R^{1′}, R^{2′}, R^{3′}, R^{4′} are the same or different and are each hydrogen, a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms, a linear or branched aliphatic hydrocarbyl radical interrupted by one or more heteroatoms, especially oxygen, NH, NR′ where R′, R^{2′}, R^{3′}, R^{4′} are the same or different and are each hydrogen, a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms, a linear or branched aliphatic hydrocarbyl radical interrupted by one or more heteroatoms, especially oxygen, NH, NR′ where R′ is a C₁-C₃₀-alkyl radical optionally containing double bonds, especially —CH₃, optionally containing double bonds and having 2 to 30 carbon atoms, a linear or branched aliphatic hydrocarbyl radical interrupted by one or more functionalities selected from the group of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, optionally containing double bonds and having 2 to 30 carbon atoms, a linear or branched, aliphatic or cycloaliphatic hydrocarbyl radical having terminal functionalization with OH, OR′, NH₂, N(H)R′, N(R′)₂ (where R′ is a C₁-C₃₀-alkyl radical optionally containing double bonds), optionally containing double bonds and having 1 to 30 carbon atoms, or a polyether of blockwise or random structure according to —(R^{5′}—O)ₙ—R^{6′},
where
R^{5′} is a linear or branched hydrocarbyl radical containing 2 to 4 carbon atoms,
n is 1 to 100, preferably 2 to 60, and
R^{6′} is hydrogen, a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms or a —C(O)—R^{7′} radical where
R^{7′} is a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms.

Useful cations for the surfactant B further include ions which derive from saturated or unsaturated cyclic compounds and from aromatic compounds each having at least one trivalent nitrogen atom in a 4- to 10-membered, preferably 5- to 6-membered, heterocyclic ring which may optionally be substituted. Such cations can be described in simplified form (i.e. without specification of the exact position and number of double bonds in the molecule) by the general formulae (IIId), (IIIe) and (IIIf) below, where the heterocyclic rings may optionally also contain two or more heteroatoms:

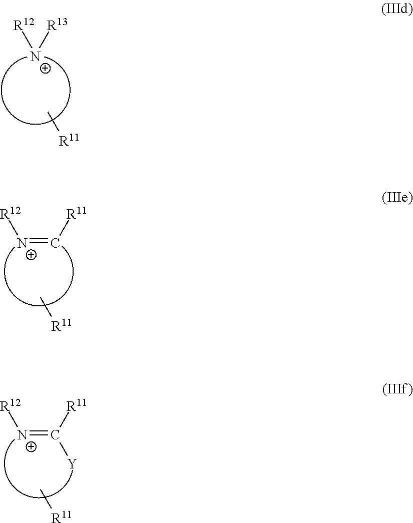

where
R¹¹ is the same or different and is a hydrogen, a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms or an alkylaryl radical having 7 to 40 carbon atoms,
R¹² and R¹³ are each as defined for R^{1′} and R^{2′},
Y is an oxygen atom or a substituted nitrogen atom (Y═O,NR^{1a}),
R^{1a} is hydrogen, a linear or branched aliphatic hydrocarbyl radical optionally containing double bonds and having 1 to 30 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms, a linear or branched aliphatic hydrocarbyl radical interrupted by one or more heteroatoms (oxygen, NH, NR′ where R′ is a C₁-C₃₀-alkyl radical optionally containing double bonds, especially —CH₃), optionally containing double bonds and having 2 to 30 carbon atoms, a linear or branched aliphatic hydrocarbyl radical interrupted by one or more functionalities selected from the group of —O—C(O)—, —(O)C—O—, —NH—C(O)—, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, optionally containing double bonds and having 2 to 30 carbon atoms, a linear or branched, aliphatic or cycloaliphatic hydrocarbyl radical having terminal functionalization with OH, OR′, NH₂, N(H)R′, N(R′)₂ (where R′ is a C₁-C₃₀-alkyl radical optionally containing double bonds), optionally containing double bonds and having 1 to 30 carbon atoms, or a polyether of blockwise or random structure according to —(R^{5′}—O)ₙ—R^{6′}.

Examples of cyclic nitrogen compounds of the aforementioned kind are pyrrolidine, dihydropyrrole, pyrrole, imidazoline, oxazoline, oxazole, isoxazole, indole, carbazole, piperidine, pyridine, the isomeric picolines and lutidines, quinoline and isoquinoline. The cyclic nitrogen compounds of the general formulae (IIId), (IIIe) and (IIIf) may be unsubstituted (R¹¹═H), monosubstituted or else polysubstituted by the R¹¹ radical, and in the case of polysubstitution by R¹¹ the individual R¹¹ radicals may be different.

Further useful cations are ions which derive from saturated acyclic, saturated or unsaturated cyclic compounds and from aromatic compounds each having more than one trivalent nitrogen atom in a 4-to 10-membered, preferably 5- to 6-membered, heterocyclic ring. These compounds may be substituted both on the carbon atoms and on the nitrogen atoms. They may also be fused by optionally substituted benzene rings and/or cyclohexane rings, to form polycyclic structures. Examples of such compounds are pyrazole, 3,5-dimethylpyrazole, imidazole, benzimidazole, N-methylimidazole, dihydropyrazole, pyrazolidine, pyridazine, pyrimidine, pyrazine, 2,3-, 2,5- and 2,6-dimethylpyrazine, cinnoline, phthalazine, quinazoline, phenazine and piperazine. Especially cations derived from imidazoline and the alkyl and phenyl derivatives thereof have been found to be useful as a constituent.

Further useful cations are ions which contain two nitrogen atoms and are represented by the general formula (IIIg)

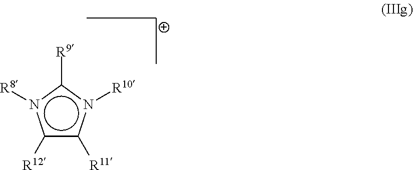

in which
R^{8′}, R^{9′}, R^{10′}, R^{11′}, R^{12′} may be the same or different and are each hydrogen, a linear or branched aliphatic hydrocarbyl radical optionally containing double bonds and having 1 to 30, preferably 1 to 8 and especially 1 to 4 carbon atoms, a cycloaliphatic hydrocarbyl radical optionally containing double bonds and having 5 to 40 carbon atoms, an aromatic hydrocarbyl radical having 6 to 40 carbon atoms, an alkylaryl radical having 7 to 40 carbon atoms, a linear or branched aliphatic hydrocarbyl radical interrupted by one or more heteroatoms (oxygen, NH, NR′ where R′ is a C₁-C₃₀-alkyl radical optionally containing double bonds), optionally containing double bonds and having 1 to 30 carbon atoms, a linear or branched aliphatic hydrocarbyl radical interrupted by one or more functionalities selected from the group of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, optionally containing double bonds and having 1 to 30 carbon atoms, a linear or branched, aliphatic or cycloaliphatic hydrocarbyl radical having terminal functionalization with OH, OR′, NH₂, N(H)R′, N(R′)₂ (where R′ is an C₁-C₃₀-alkyl radical optionally containing double bonds), optionally containing double bonds and having 1 to 30 carbon atoms, or a polyether of blockwise or random structure formed from —(R^{5′}—O)ₙ—R^{6′} where R^{5′}, n and R^{6′} are as defined above,

The anions X⁻ in the surfactant B are preferably selected from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates.

As anions X⁻, the surfactants B usable in accordance with the invention preferably have a chloride, phosphate or methylsulphate anion, preferably a methylsulphate anion.

It may be advantageous when the additive composition for use in accordance with the invention includes at least one oxazasilinane. As oxazasilinane, the composition according to the invention preferably contains 2,2,4-trimethyl-1,4,2-oxazasilinane (formula (V))

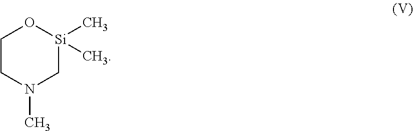

In a preferred embodiment of the invention, the additive composition for use in accordance with the invention comprises at least one tertiary amine compound C which is not an oxazasilinane and has a molar mass of at least 150 g/mol, more preferably of at least 200 g/mol, and which preferably, in a concentration of 0.5% by mass in water, lowers the static surface tension of this solution to less than 40 N/m, and also at least one oxazasilinane.

Preferably, the surfactant A is selected from those of the formula (IIa)

R¹⁴—SO₃⁻M⁺ (IIa)

with R¹⁴=organic radical, especially hydrocarbyl radical or —O-hydrocarbyl radical, preferably R¹⁴=saturated or unsaturated hydrocarbyl radicals having 5 to 30 and preferably 8 to 20 carbon atoms, aryl radicals or alkylaryl radicals, and M⁺=cation, preferably alkali metal cation, more preferably sodium cation. Preferred ionic surfactants A are, for example, those of the formulae (IIb) to (IId)

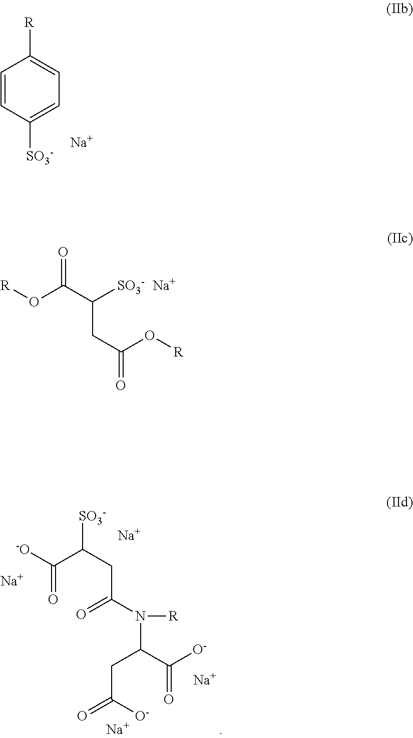

Preferred ionic surfactants B are especially imidazolium compounds, more preferably those of the formula (IIIh)

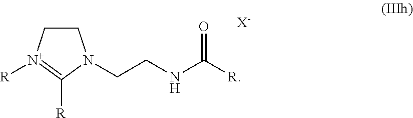

The R radicals in the formulae (IIb) to (IId) and (IIIh) may be identical or different, saturated or unsaturated, optionally alkoxylated hydrocarbyl radicals having 1 to 30 and preferably 1 to 20 carbon atoms.

In the formula IIIh, X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion.

The amines C usable in accordance with the invention are preferably nonionic, i.e. do not have any electrical charge. Preferred amines C are, for example, those of the formula (IV)

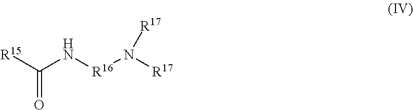

where
R¹⁵=saturated or unsaturated hydrocarbyl radicals having 5 to 30 and preferably 8 to 20 carbon atoms,
R¹⁶=divalent alkyl radical having 2 or 3 carbon atoms,
R¹⁷=identical or different, preferably identical, alkyl radicals having 1 to 3 carbon atoms, preferably methyl radicals.
A particularly preferred amine C is a dimethylaminopropylcocoamide.

The amount of surfactant A is preferably chosen such that 0.001 to 5 parts by weight, especially 0.01 to 3 parts by weight, more preferably 0.05 to 1 part by weight, of surfactant A are used per 100 parts of polyol used in total.

The amount of surfactant B is preferably chosen such that 0.001 to 5 parts by weight, especially 0.01 to 3 parts by weight, more preferably 0.05 to 1 part by weight, of surfactant B are used per 100 parts of polyol used in total.

The amount of amine C is preferably chosen such that 0.001 to 5 parts by weight, especially 0.01 to 3 parts by weight, more preferably 0.05 to 1 part by weight, of amine C are used per 100 parts of polyol used in total.

The amount of oxazasilinane D is preferably chosen such that 0.0005 to 1 part by weight, especially 0.001 to 0.5 part by weight, of oxazasilinane D is used per 100 parts of the total amount of polyol used.

In the additive composition for use in accordance with the invention, the mass ratio of the sum total of all the surfactants A and B to the sum total of all the amines C is preferably from 20:1 to 1:10, more preferably 10:1 to 1:10 and especially preferably from 5:1 to 1:5.

If the additive composition for use in accordance with the invention contains one or more oxazasilinanes D, the mass ratio of the sum total of all the amines C to the sum total of all the oxazasilinanes D is preferably from 500:1 to 1:1, more preferably from 200:1 to 5:1 and especially preferably from 50:1 to 10:1. As oxazasilinane, the additive composition for use in accordance with the invention preferably contains 2,2,4-trimethyl-1,4,2-oxazasilinane of formula (V)

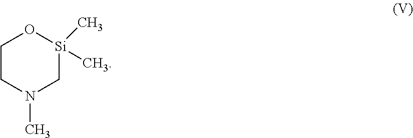

The additive composition for use in accordance with the invention can be used as such or in combination with other substances used for production of polyurethane foams.

As well as the usable components a to d, the additive composition for use in accordance with the invention may accordingly comprise one or more further substances usable in the production of polyurethane foams, especially selected from nucleating agents, stabilizers, cell openers, crosslinkers, emulsifiers, flame retardants, antioxidants, antistats, biocides, color pastes, solid fillers, amine catalysts, metal catalysts and buffer substances. At the same time, in a very particularly preferred embodiment, the additive composition for use in accordance with the invention contains 0% to 90% by weight, preferably 10% to 80% by weight, more preferably 20% to 70% by weight, based on the overall additive composition, of one or more inorganic or organic solvents, preferably selected from water, alcohols, especially polyether monools or polyether polyols, preferably consisting of H-functional starter substances onto which have been added, by means of alkoxylation, alkylene oxides (epoxides) having 2-24 carbon atoms, preferably ethylene oxide and/or propylene oxide, and which have a molecular weight of preferably 200-8000 g/mol, more preferably of 300-5000 g/mol, especially preferably of 500-1000 g/mol, and a PO content of preferably 10%-100% by weight, preferably of 50%-100% by weight, and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin, based on the additive composition.

Preferably, in the process according to the invention, polyol components used are mixtures of polyols containing at least 10% by weight, further advantageously at least 20% by weight, further advantageously at least 30% by weight, preferably at least 50% by weight and especially at least 75% by weight of polyether polycarbonate polyols, based on the total amount of polyol used. In a further preferred embodiment of the invention, the polyol component used is exclusively polyether polycarbonate polyol.

Preferably, the polyol has a total content of carbonate groups (calculated as CO₂) of at least 1% by weight, preferably of at least 5% by weight, more preferably of at least 10% by weight and most preferably of 15% to 50% by weight.

The amount of additive composition is preferably chosen such that 0.001 to 10 parts by weight, especially 0.2 to 5 parts by weight, of additive composition are used per 100 parts of the total amount of polyol used.

The amount of additive composition may preferably be chosen such that the mass ratio of all the polyol components used to the sum total of all the amines C used is from 2000:1 to 5:1, preferably from 1000:1 to 10:1 and more preferably from 250:1 to 20:1.

In a preferred embodiment of the invention, an additive composition comprising at least 2 components is used in the process according to the invention:
(i) at least one ionic surfactant B selected from a quaternized ammonium compound, at least one imidazolium compound, especially an imidazolium compound of the formula (IIIh),

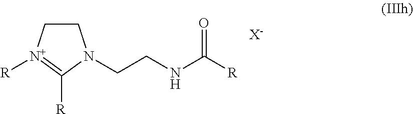

with R=identical or different, saturated or unsaturated, optionally alkoxylated hydrocarbyl radicals having 1 to 30 carbon atoms,
X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion.
(ii) at least one oxazasilinane D, especially 2,2,4-trimethyl-1,4,2-oxazasilinane of the formula (V)

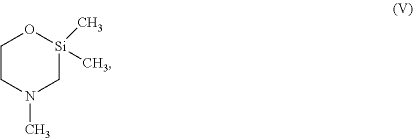

polyol components used being mixtures of polyols advantageously containing at least 10% by weight, further advantageously at least 20% by weight, even further advantageously at least 30% by weight, preferably at least 50% by weight and especially at least 75% by weight of polyether polycarbonate polyol, based on the total amount of polyol used.

In a preferred embodiment of the invention, an additive composition comprising at least 2 components is used in the process according to the invention:
(i) as tertiary amine compound C which has a molar mass of preferably at least 150 g/mol, more preferably at least 200 g/mol, and which preferably, in a concentration of 0.5% by mass in water, lowers the static surface tension of this solution to less than 40 N/m, at least one compound of the formula (IV)

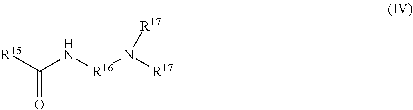

where
R¹⁵=saturated or unsaturated hydrocarbyl radicals having 5 to 30 and preferably 8 to 20 carbon atoms,
R¹⁶=divalent alkyl radical having 2 or 3 carbon atoms,
R¹⁷=identical or different, preferably identical, alkyl radicals having 1 to 3 carbon atoms, preferably methyl radicals,
especially dimethylaminopropylcocoamide,
(ii) at least one ionic surfactant B selected from a quaternized ammonium compound, at least one imidazolium compound, especially an imidazolium compound of the formula (IIIh),

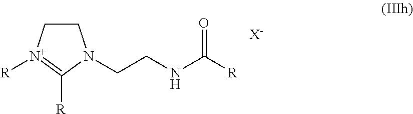

with R=identical or different, saturated or unsaturated, optionally alkoxylated hydrocarbyl radicals having 1 to 30 carbon atoms,
X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion,
   polyol components used being mixtures of polyols advantageously containing at least 10% by weight, further advantageously at least 20% by weight, even further advantageously at least 30% by weight, preferably at least 50% by weight and especially at least 75% by weight of polyether polycarbonate polyol, based on the total amount of polyol used.

In a particularly preferred embodiment of the invention, an additive composition comprising at least 3 components is used in the process according to the invention:
(i) as tertiary amine compound C which has a molar mass of preferably at least 150 g/mol, more preferably at least 200 g/mol, and which preferably, in a concentration of 0.5% by mass in water, lowers the static surface tension of this solution to less than 40 N/m, at least one compound of the formula (IV)

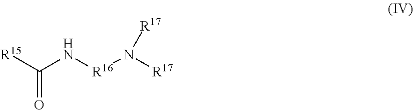

where
R¹⁵=saturated or unsaturated hydrocarbyl radicals having 5 to 30 and preferably 8 to 20 carbon atoms,
R¹⁶=divalent alkyl radical having 2 or 3 carbon atoms,
R¹⁷ =identical or different, preferably identical, alkyl radicals having 1 to 3 carbon atoms, preferably methyl radicals,
especially dimethylaminopropylcocoamide,
(ii) at least one ionic surfactant B selected from a quaternized ammonium compound, at least one imidazolium compound, especially an imidazolium compound of the formula (IIIh),

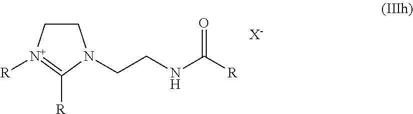

with R=identical or different, saturated or unsaturated, optionally alkoxylated hydrocarbyl radicals having 1 to 30 carbon atoms,
X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion,
(ii) at least one oxazasilinane D, especially 2,2,4-trimethyl-1,4,2-oxazasilinane of the formula (V)

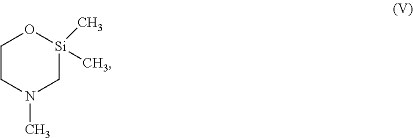

polyol components used being mixtures of polyols advantageously containing at least 10% by weight, further advantageously at least 20% by weight, even further advantageously at least 30% by weight, preferably at least 50% by weight and especially at least 75% by weight of polyether polycarbonate polyol, based on the total amount of polyol used.

In a particular embodiment of the invention, no fatty acid ester sulphates are used in the process according to the invention.

Preferably, the PU system, especially PU foam, is made by expanding a mixture containing at least one urethane and/or isocyanurate catalyst, at least one blowing agent and/or water, at least one isocyanate component and a polyol mixture containing a polyether polycarbonate polyol, in the presence of the additive composition according to the invention.

As well as the components mentioned, the mixture may include further constituents, for example optionally (further) blowing agents, optionally prepolymers, optionally flame retardants and optionally further additives (other than those mentioned in the additive composition according to the invention), for example fillers, emulsifiers based on the reaction of hydroxyl-functional compounds with isocyanate, stabilizers, for example Si-containing and non-Si-containing, especially Si-containing and non-Si-containing organic stabilizers and surfactants, viscosity reducers, dyes, antioxidants, UV stabilizers or antistats. It will be understood that a person skilled in the art seeking to produce the different types of flexible polyurethane foam, i.e. hot-cure, cold-cure or ester flexible polyurethane foams, will select the particular substances needed for this, e.g. isocyanate, polyol, prepolymer, stabilizers, etc., in an appropriate manner to obtain the particular type of flexible polyurethane foam desired.

A number of property rights describing suitable components and processes for producing the different types of flexible polyurethane foam, i.e. hot-cure, cold-cure and also ester flexible polyurethane foams, are indicated hereinbelow and are fully incorporated herein by reference: EP 0152878 A1, EP 0409035 A2, DE 102005050473 A1, DE 19629161 A1, DE 3508292 A1, DE 4444898 A1, EP 1061095 A1, EP 0532939 B1, EP 0867464 B1, EP 1683831 A1 and DE 102007046860 A1.

Further details of usable starting materials, catalysts and auxiliaries and derivatives can be found, for example, in Kunststoff-Handbuch [Plastics Handbook], volume 7, Polyurethane [Polyurethanes], Carl-Hanser-Verlag Munich, 1st edition 1966, 2nd edition 1983 and 3rd edition 1993.

The compounds, components and additives which follow are mentioned merely by way of example and can be replaced by other substances known to those skilled in the art.

Further surfactants employed in the production of flexible polyurethane foams are selectable, for example, from the group comprising nonionic surfactants and/or amphoteric surfactants.

Surfactants used may, in accordance with the invention, for example, also be polymeric emulsifiers such as polyalkyl polyoxyalkyl polyacrylates, polyvinylpyrrolidones or polyvinyl acetates. It is likewise possible to use, as surfactants/emulsifiers, prepolymers which are obtained by reaction of small amounts of isocyanates with polyols (called oligourethanes), and which are preferably present dissolved in polyols.

Foam stabilizers used may preferably be those which are known from the prior art and which are typically also employed for polyurethane foam stabilization. These may be both Si-containing and non-Si-containing, especially Si-containing and non-Si-containing organic stabilizers and surfactants. The Si-containing stabilizers are further distinguished by whether the polyoxyalkylene block is bonded to the polysiloxane block by a hydrolytically stable C—Si bond (as, for example, in EP 2182020) or by the less hydrolytically stable C—O—Si bond. The SiC-polysiloxane-polyoxyalkylene block copolymers usable for polyurethane foam stabilization can be prepared, for example, by noble metal-catalysed hydrosilylation of unsaturated polyoxyalkylenes with SiH-functional siloxanes, called hydrosiloxanes, as described, for example, in EP 1520870. The hydrosilylation can be conducted batchwise or continuously, as described, for example, in DE 19859759 C1.

A multitude of further documents, for example EP 0493836 A1, U.S. Pat. No. 5,565,194 or EP 1350804, each disclose polysiloxane-polyoxyalkylene block copolymers of a specific composition for fulfilment of specific profiles of demands for foam stabilizers in various polyurethane foam formulations.

Biocides used may be commercial products such as chlorophene, benzisothiazolinone, hexahydro-1,3,5-tris(hydroxyethyl-s-triazine), chloromethylisothiazolinone, methylisothiazolinone or 1,6-dihydroxy-2,5-dioxohexane, which are known by the trade names BIT 10, Nipacide BCP, Acticide MBS, Nipacide BK, Nipacide CI, Nipacide FC.

Suitable flame retardants for the purposes of this invention are any substances considered suitable therefor in the prior art. Examples of preferred flame retardants are liquid organophosphorus compounds such as halogen-free organophosphates, e.g. triethyl phosphate (TEP), halogenated phosphates, e.g. tris(1-chloro-2-propyl) phosphate (TCPP), tris(1,3-dichloro-2-propyl)phosphate (TDCPP) and tris(2-chloroethyl)phosphate (TCEP), and organic phosphonates, e.g. dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine. All these flame retardants and combinations thereof can be utilized advantageously in the context of this invention; these also include all the commercially available flame retardants from Great Lakes Solutions (Chemtura) (e.g.: DP-54™, Firemaster® BZ-54 HP, Firemaster® 550, Firemaster® 552, Firemaster® 600, Firemaster® 602, Reofos® 50, Reofos® 65, Reofos® 95, Kronitex® CDP), ICL Industrial Products (e.g.: FR-513, FR-1210, FR-1410, Fyrol™ FR-2, Fyrol™ 38, Fyrol™ HF-5, Fyrol™ A300TB, Fyrol™ PCF, Fyrol™ PNX, Fyrol™ PNX-LE), Clariant (e.g.: Exolit® OP 550 or Exolit® OP 560).

It is often the case that all the components except for the polyols and isocyanates are mixed to give an activator solution prior to the foaming. This solution then preferably comprises, inter alia, the additive composition usable in accordance with the invention, stabilizers, catalysts or catalyst combination, the blowing agent, for example water, and also any further additives, such as flame retardation, color, biocides, etc., depending on the recipe of the flexible polyurethane foam. An activator solution of this type may also be a composition according to the invention.

The blowing agents are distinguished between chemical and physical blowing agents. The chemical blowing agents include, for example, water, the reaction of which with the isocyanate groups leads to formation of CO₂. The density of the foam can be controlled via the amount of water added, the preferred use amounts of water being between 0.5 and 10 parts, preferably between 1 and 7 parts, more preferably between 1 and 5 parts, based on 100.0 parts of polyol. In addition, it is alternatively and/or else additionally possible to use physical blowing agents. These are liquids which are inert to the formulation constituents and have boiling points below 100° C., preferably below 50° C., especially between −50° C. and 30° C., at atmospheric pressure, such that they evaporate under the influence of the exothermic polyaddition reaction. Examples of such liquids usable with preference are ketones such as acetone and/or methyl ethyl ketone, hydrocarbons such as n-, iso- or cyclopentane, n- or isobutane and propane, cyclohexane, ethers such as dimethyl ether and diethyl ether, halogenated hydrocarbons such as methylene chloride, tetrafluoroethane, pentafluoropropane, heptafluoropropane, pentafluorobutane, hexafluorobutane and/or dichloromonofluoroethane, trichlorofluoromethane, dichlorotetrafluoroethane and 1,1,2-trichloro-1,2,2-trifluoroethane. In addition, it is also possible to use carbon dioxide. It is also possible to use mixtures of these low-boiling liquids with one another and/or with other substituted or unsubstituted hydrocarbons. The foaming may proceed either under standard pressure or under reduced pressure (VPF technology).

The amount of physical blowing agent here is preferably in the range between 1 and 50 parts by weight, in particular between 1 and 15 parts by weight, while the amount of water is preferably in the range between 0.5 and 10 parts by weight, in particular 1 and 5 parts by weight. Carbon dioxide is preferred among the physical blowing agents, and is preferably used in combination with water as chemical blowing agent.

The activator solution may additionally comprise all the customary additives known for activator solutions in the prior art. The additives may be selected from the group comprising flame retardants, antioxidants, UV stabilizers, dyes, biocides, pigments, cell openers, crosslinkers and the like.

A flexible polyurethane foam is preferably produced by reacting a mixture (mix) of polyol comprising polyether polycarbonate polyol, di- or polyfunctional isocyanate, additive composition according to the invention, amine catalyst, potassium compound, organozinc compound and/or organotin compound or other metal-containing catalysts, stabilizer, blowing agent, preferably water to form CO₂ and, if necessary, addition of physical blowing agents, optionally under admixture of flame retardants, antioxidants, UV stabilizers, color pastes, biocides, fillers, crosslinkers or other customary processing auxiliaries. Such a mixture likewise forms part of the subject-matter of the invention. A mixture comprising the additive composition for use in accordance with the invention and polyol comprising polyether polycarbonate polyol likewise forms part of the subject-matter of the invention.

Isocyanates used may be organic isocyanate compounds containing at least two isocyanate groups. In general, useful isocyanates are the aliphatic, cycloaliphatic, araliphatic and preferably aromatic polyfunctional isocyanates known per se. Isocyanates are more preferably used at from 60 to 140 mol %, relative to the sum total of isocyanate-consuming components.

Specific examples include the following: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate, cycloaliphatic diisocyanates such as cyclohexane 1,3- and 1,4-diisocyanate and any desired mixtures of these isomers, 1-isocyanato-3,3,5-trimethyl-5-isocyanatomethylcyclohexane (IPDI), hexahydrotolylene 2,4- and 2,6-diisocyanate and the corresponding isomer mixtures, dicyclohexylmethane 4,4′-, 2,2′- and 2,4′-diisocyanate and the corresponding isomer mixtures, and preferably aromatic di- and polyisocyanates, for example tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. Organic di- and polyisocyanates can be used individually or as mixtures thereof.

It is also possible to use isocyanates which have been modified by the incorporation of urethane, uretdione, isocyanurate, allophanate and other groups, called modified isocyanates.

Organic polyisocyanates have been found to be particularly useful and are therefore employed with preference:

tolylene diisocyanate, mixtures of diphenylmethane diisocyanate isomers, mixtures of diphenylmethane diisocyanate and polyphenylpolymethyl polyisocyanate or tolylene diisocyanate with diphenylmethane diisocyanate and/or polyphenylpolymethyl polyisocyanate or what are called prepolymers.

It is possible to use either TDI (tolylene 2,4- and 2,6-diisocyanate isomer mixture) or MDI (diphenylmethane 4,4′-diisocyanate). What is called “crude MDI” or “polymeric MDI” contains, as well as the 4,4′ isomers, also the 2,4′ and 2,2′ isomers, and also higher polycyclic products. “Pure MDI” refers to bicyclic products composed predominantly of 2,4′ and 4,4′ isomer mixtures or prepolymers thereof. Further suitable isocyanates are detailed in patent specification EP 1095968, to which reference is made here in full.

Crosslinkers refer to low molecular weight polyfunctional compounds that are reactive towards isocyanates. Suitable examples are polyfunctional, especially di- and trifunctional compounds having molecular weights of 62 to 1000 g/mol, preferably 62 to 600 g/mol. Those used include, for example, di- and trialkanolamines such as diethanolamine and triethanolamine, aliphatic and aromatic diamines, for example ethylenediamine, butylenediamine, butylene-1,4-diamine, hexamethylene-1,6-diamine, 4,4′-diaminodiphenylmethane, 3,3′-dialkyl-substituted 4,4′-diaminodiphenylmethanes, tolylene-2,4- and -2,6-diamine, and preferably aliphatic diols and triols having 2 to 6 carbon atoms, such as ethylene glycol, propylene glycol, 1,4-butylene glycol, 1,6-hexamethylene glycol, 2-methylpropane-1,3-diol, glycerol and trimethylolpropane or castor oil or pentaerythritol, and also higher polyhydric alcohols such as sugar alcohols, for example sucrose, glucose or sorbitol, and alkoxylated compounds of all the aforementioned examples.

The compositions according to the invention can be used in slabstock foaming. It is possible to use all processes known to those skilled in the art for production of free-rise flexible polyurethane foams. For example, the foaming operation can be effected either in the horizontal or in the vertical direction, in batchwise or continuous systems. The additive compositions usable in accordance with the invention can be similarly used for CO₂ technology. Use in low-pressure and high-pressure machines is possible, in which case the formulations of the invention can be metered directly into the mixing chamber or else are added upstream of the mixing chamber to one of the components which subsequently pass into the mixing chamber. The addition can also be effected in the raw material tank.

As well as the polyether polycarbonate polyols, further polyol components present in the mixture may optionally be all the known polyol compounds.

Polyols suitable as polyol component for the purposes of the present invention are all organic substances having two or more isocyanate-reactive groups, preferably OH groups, and also formulations thereof. All polyether polyols and polyester polyols typically used for production of polyurethane systems, especially polyurethane foams, are preferred polyols.

These may, for example, be polyether polyols or polyester polyols which typically bear 2 to 8 OH groups per molecule and, as well as carbon, hydrogen and oxygen, may also contain heteroatoms such as nitrogen, phosphorus or halogens; preference is given to using polyether polyols. Polyols of this kind can be prepared by known processes, for example by anionic polymerization of alkylene oxides in the presence of alkali metal hydroxides or alkali metal alkoxides as catalysts, and with addition of at least one starter molecule containing preferably 2 or 3 reactive hydrogen atoms in bound form, or by cationic polymerization of alkylene oxides in the presence of Lewis acids, for example antimony pentachloride or boron fluoride etherate, or by double metal cyanide catalysis. Suitable alkylene oxides contain from 2 to 4 carbon atoms in the alkylene moiety. Examples are tetrahydrofuran, 1,2-propylene oxide, 1,2- or 2,3-butylene oxide; preference is given to using ethylene oxide and/or 1,2-propylene oxide. The alkylene oxides may be used individually, in alternation or as mixtures. H-functional starter substances used are especially polyfunctional alcohols and/or amines. Alcohols used with preference are dihydric alcohols, for example ethylene glycol, propylene glycol, or butanediols, trihydric alcohols, for example glycerol, trimethylolpropane or castor oil or pentaerythritol, and higher polyhydric alcohols, such as sugar alcohols, for example sucrose, glucose or sorbitol. Amines used with preference are aliphatic amines having up to 10 carbon atoms, for example ethylenediamine, diethylenetriamine, propylenediamine, aromatic amines, for example tolylenediamine or diaminodiphenylmethane, and also amino alcohols such as ethanolamine or diethanolamine.

Polyester polyols can be prepared by polycondensation reaction or by ring-opening polymerization. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of said acids and/or anhydrides. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. If the alcohol component used is dihydric or polyhydric polyether polyols, the result is polyester ether polyols which can likewise serve as starter substances for preparation of the polyether polycarbonate polyols. Preference is given to using polyether polyols having Mn=150 to 2000 g/mol for preparation of the polyester ether polyols.

The polyether polyols, preferably polyoxypropylenepolyoxyethylene polyols, typically have a functionality of 2 to 8 and number-averaged molecular weights preferably in the range from 500 to 8000, preferably 800 to 4500. Further polyols are known to those skilled in the art and can be found, for example, in EP-A-0380993 or U.S. Pat. No. 3,346,557, to which reference is made in full.

High-elasticity flexible polyurethane foams (cold-cure foam) are preferably produced by employing di- and/or trifunctional polyether alcohols preferably having above 50 mol % of primary hydroxyl groups, based on the sum total of hydroxyl groups, in particular those having an ethylene oxide block at the chain end or those based exclusively on ethylene oxide.

Slabstock flexible foams are preferably produced by employing di- and/or trifunctional polyether alcohols having secondary hydroxyl groups, preferably above 80 mol %, in particular those having a propylene oxide block or random propylene oxide and ethylene oxide block at the chain end, or those based exclusively on propylene oxide blocks.

A further class of polyols is of those which are obtained as prepolymers by reaction of polyol with isocyanate in a molar ratio of 100:1 to 5:1, preferably 50:1 to 10:1. Such prepolymers are preferably used in the form of a solution in polyol, and the polyol preferably corresponds to the polyol used for preparing the prepolymers.

Yet a further class of polyols is that of the so-called filled polyols (polymer polyols). These contain dispersed solid organic fillers up to a solids content of 40% by weight or more. Those used include the following:
SAN polyols: These are highly reactive polyols containing a dispersed copolymer based on styrene-acrylonitrile (SAN).
PUD polyols: These are highly reactive polyols containing polyurea, likewise in dispersed form.
PIPA polyols: These are highly reactive polyols containing a dispersed polyurethane, for example formed by in situ reaction of an isocyanate with an alkanolamine in a conventional polyol.

The solids content, which is preferably between 5% and 40% by weight, based on the polyol, depending on the application, is responsible for improved cell opening, and so the polyol can be foamed in a controlled fashion, especially with TDI, and no shrinkage of the foams occurs. The solids content thus acts as an essential processing aid. A further function is to control the hardness via the solids content, since higher solids contents bring about a higher hardness on the part of the foam.

The formulations with solids-containing polyols have distinctly lower intrinsic stability and therefore tend also to additionally require physical stabilization in addition to the chemical stabilization due to the crosslinking reaction.

Depending on the solids content of the polyols, these are used alone or in a blend with the abovementioned unfilled polyols.

A further class of useful polyols is that of the so-called autocatalytic polyols, in particular autocatalytic polyether polyols. Polyols of this kind are based, for example, on polyether blocks, preferably on ethylene oxide and/or propylene oxide blocks, and additionally include catalytically active functional groups, for example nitrogen-containing functional groups, especially amino groups, preferably tertiary amine functions, urea groups and/or heterocycles containing nitrogen atoms. Through the use of such autocatalytic polyols in the production of polyurethane systems, especially of polyurethane foams, preferably of flexible polyurethane foams, it is possible, as the case may be, to reduce the required amount of any catalysts used in addition, depending on application, and/or to match it to specific desired foam properties. Suitable polyols are described, for example, in WO0158976 (A1), WO2005063841 (A1), WO0222702 (A1), WO2006055396 (A1), WO03029320 (A1), WO0158976 (A1), U.S. Pat. No. 6,924,321 (B2), U.S. Pat. No. 6,762,274 (B2), EP2104696 (B1), WO2004060956 (A1) or WO2013102053 (A1) and can be purchased, for example, under the Voractiv™ and/or SpecFlex™ Activ trade names from Dow.

Blowing agents used may be the known blowing agents. Preferably, in the production of the polyurethane foam, water, methylene chloride, pentane, alkanes, halogenated alkanes, acetone and/or carbon dioxide are used as blowing agents.

The water can be added directly to the mixture or else be added to the mixture as a secondary component of one of the reactants, for example of the polyol component, together with the latter.

In addition to physical blowing agents and any water, it is also possible to use other chemical blowing agents which react with isocyanates to evolve a gas, an example being formic acid.

Catalysts used in the context of this invention may, for example, be any catalysts for the isocyanate-polyol (urethane formation) and/or isocyanate-water (amine and carbon dioxide formation) and/or isocyanate dimerization (uretdione formation), isocyanate trimerization (isocyanurate formation), isocyanate-isocyanate with CO₂ elimination (carbodiimide formation) and/or isocyanate-amine (urea formation) reactions and/or “secondary” crosslinking reactions such as isocyanate-urethane (allophanate formation) and/or isocyanate-urea (biuret formation) and/or isocyanate-carbodiimide (uretonimine formation).

Suitable catalysts for the purposes of the present invention are, for example, substances which catalyze one of the aforementioned reactions, especially the gelling reaction (isocyanate-polyol), the blowing reaction (isocyanate-water) and/or the dimerization or trimerization of the isocyanate. Such catalysts are preferably nitrogen compounds, especially amines and ammonium salts, and/or metal compounds.

Suitable nitrogen compounds as catalysts, also referred to hereinafter as nitrogenous catalysts, for the purposes of the present invention are all nitrogen-containing compounds according to the prior art which catalyze one of the abovementioned isocyanate reactions and/or can be used for production of polyurethanes, especially of polyurethane foams.

Examples of suitable nitrogen compounds as catalysts for the purposes of the present invention are preferably amines, especially tertiary amines or compounds containing one or more tertiary amine groups, including the amines triethylamine, N,N-dimethylcyclohexylamine, N,N-dicyclohexylmethylamine, N,N-dimethylaminoethylamine, N,N,N′,N′-tetramethylethylene-1,2-diamine, N,N,N′,N′-tetramethylpropylene-1,3-diamine, N,N,N′,N′-tetramethyl -1,4-butanediamine, N,N,N′,N′-tetramethyl -1,6-hexanediamine, N,N,N′,N″,N″-pentamethyldiethylenetriamine, N,N,N′-trimethylaminoethylethanolamine, N,N-dimethylaminopropylamine, N,N-diethylaminopropylamine, N,N-dimethylaminopropyl-N′,N′-dipropan-2-olamine, 2-[[3-(dimethylamino)propyl]methylamino]ethanol, 3-(2-dimethylamino)ethoxy)propylamine, N,N-bis[3-(dimethylamino)propyl]amine, N,N,N′,N″,N″-pentamethyldipropylenetriamine, 1-[bis[3-(dimethylamino)propyl]amino]-2-propanol, N,N-bis[3-(dimethylamino)propyl]-N′,N′-dimethylpropane-1,3-diamine, triethylenediamine, 1,4-diazabicyclo[2.2.2]octane-2-methanol, N,N′-dimethylpiperazine, 1,2-dimethylimidazole, N-(2-hydroxypropyl)imidazole, 1-isobutyl-2-methylimidazole, N-(3-aminopropyl)imidazole, N-methylimidazole, N-ethylmorpholine, N-methylmorpholine, 2,2,4-trimethyl-2-silamorpholine, N-ethyl-2,2-dimethyl-2-silamorpholine, N-(2-aminoethyl)morpholine, N-(2-hydroxyethyl)morpholine, 2,2′-dimorpholinodiethyl ether, N,N′-dimethylpiperazine, N-(2-hydroxyethyl)piperazine, N-(2-aminoethyl)piperazine, N,N-dimethylbenzylamine, N,N-dimethylaminoethanol, N,N-diethylaminoethanol, 3-dimethylamino-1-propanol, N,N-dimethylaminoethoxyethanol, N,N-diethylaminoethoxyethanol, bis(2-dimethylaminoethyl ether), N,N,N′-trimethyl-N′-(2-hydroxyethyl)bis(2-aminoethyl) ether, N,N,N′-trimethyl-N-3′-aminopropyl(bisaminoethyl)ether, tris(dimethylaminopropyl)hexahydro-1,3,5-triazine, 1,8-diazabicyclo[5.4.0]undec-7-ene, 1,5-diazabicyclo[4.3.0]non-5-ene, 1,5,7-triazabicyclo[4.4.0]dec-5-ene, N-methyl-1,5,7-triazabicyclo[4.4.0]dec-5-ene, 1,4,6-triazabicyclo[3.3.0]oct-4-ene, 1,1,3,3-tetramethylguanidine, tert-butyl-1,1,3,3-tetramethylguanidine, guanidine, 3-dimethylaminopropylurea, 1,3-bis[3-(dimethylamino)propyl]urea, bis-N,N-(dimethylaminoethoxyethyl)isophoronedicarbamate, 3-dimethylamino-N,N-dimethylpropionamide and 2,4,6-tris(dimethylaminomethyl)phenol. Suitable nitrogenous catalysts according to the prior art can be purchased, for example, from Evonik under the TEGOAMIN® trade name.

According to the application, it may be preferable that, in the inventive production of polyurethane foams, quaternized and/or protonated nitrogenous catalysts, especially quaternized and/or protonated tertiary amines, are used.

For possible quaternization of nitrogenous catalysts, it is possible to use any reagents known as quaternizing reagents. Preferably, quaternizing agents used are alkylating agents, for example dimethyl sulphate, methyl chloride or benzyl chloride, preferably methylating agents such as dimethyl sulphate in particular. Quaternization is likewise possible with alkylene oxides, for example ethylene oxide, propylene oxide or butylene oxide, preferably with subsequent neutralization with inorganic or organic acids.

Nitrogenous catalysts, if quaternized, may be singly or multiply quaternized. Preferably, the nitrogenous catalysts are only singly quaternized. In the case of single quaternization, the nitrogenous catalysts are preferably quaternized on a tertiary nitrogen atom.

Nitrogenous catalysts can be converted to the corresponding protonated compounds by reaction with organic or inorganic acids. These protonated compounds may be preferable, for example, when, for example, a slowed polyurethane reaction is to be achieved or when the reaction mixture is to have enhanced flow in use.

Useful organic acids include, for example, any hereinbelow recited organic acids, for example carboxylic acids having 1 to 36 carbon atoms (aromatic or aliphatic, linear or branched), for example formic acid, lactic acid, 2-ethylhexanoic acid, salicylic acid and neodecanoic acid, or else polymeric acids such as, for example, polyacrylic or polymethacrylic acids. Inorganic acids used may, for example, be phosphorus-based acids, sulphur-based acids or boron-based acids.

However, the use of nitrogenous catalysts which have not been quaternized or protonated is particularly preferred in the context of this invention.

Suitable metal compounds as catalysts, also referred to hereinafter as metallic catalysts, for the purposes of the present invention are all metal compounds according to the prior art which catalyze one of the abovementioned isocyanate reactions and/or can be used for production of polyurethanes, especially of polyurethane foams. They may be selected, for example, from the group of the metal-organic or organometallic compounds, metal-organic or organometallic salts, organic metal salts, inorganic metal salts, and from the group of the charged or uncharged metallic coordination compounds, especially the metal chelate complexes.

The expression “metal-organic or organometallic compounds” in the context of this invention especially encompasses the use of metal compounds having a direct carbon-metal bond, also referred to here as metal organyls (e.g. tin organyls) or organometallic compounds (e.g. organotin compounds). The expression “organometallic or metal-organic salts” in the context of this invention especially encompasses the use of metal-organic or organometallic compounds having salt character, i.e. ionic compounds in which either the anion or cation is organometallic in nature (e.g. organotin oxides, organotin chlorides or organotin carboxylates). The expression “organic metal salts” in the context of this invention especially encompasses the use of metal compounds which do not have any direct carbon-metal bond and are simultaneously metal salts, in which either the anion or the cation is an organic compound (e.g. tin(II) carboxylates). The expression “inorganic metal salts” in the context of this invention especially encompasses the use of metal compounds or of metal salts in which neither the anion nor the cation is an organic compound, e.g. metal chlorides (e.g. tin(II) chloride), pure metal oxides (e.g. tin oxides) or mixed metal oxides, i.e. containing a plurality of metals, and/or metal silicates or aluminosilicates. The expression “coordination compound” in the context of this invention especially encompasses the use of metal compounds formed from one or more central particles and one or more ligands, the central particles being charged or uncharged metals (e.g. metal- or tin-amine complexes). The expression “metal-chelate complexes” is to be understood for the purposes of this invention as comprehending in particular the use of metal-containing coordination compounds wherein the ligands have at least two sites for coordinating or binding with the metal center (e.g. metal- or to be more precise tin-polyamine or metal- or to be more precise tin-polyether complexes).

Suitable metal compounds, especially as defined above, as additional catalysts for the purposes of the present invention may, for example, be selected from all metal compounds containing lithium, sodium, potassium, magnesium, calcium, scandium, yttrium, titanium, zirconium, vanadium, niobium, chromium, molybdenum, tungsten, manganese, cobalt, nickel, copper, zinc, mercury, aluminum, gallium, indium, germanium, tin, lead and/or bismuth, especially sodium, potassium, magnesium, calcium, titanium, zirconium, molybdenum, tungsten, zinc, aluminum, tin and/or bismuth, more preferably tin, bismuth, zinc and/or calcium.

Suitable organometallic salts and organic metal salts, as defined above, as catalysts for the purposes of the present invention are, for example, organotin, tin, zinc, bismuth and potassium salts, in particular corresponding metal carboxylates, alkoxides, thiolates and mercaptoacetates, for example dibutyltin diacetate, dimethyltin dilaurate, dibutyltin dilaurate (DBTDL), dioctyltin dilaurate (DOTDL), dimethyltin dineodecanoate, dibutyltin dineodecanoate, dioctyltin dineodecanoate, dibutyltin dioleate, dibutyltin bis(n-lauryl mercaptide), dimethyltin bis(n-lauryl mercaptide), monomethyltin tris(2-ethylhexyl mercaptoacetate), dimethyltin bis(2-ethylhexyl mercaptoacetate), dibutyltin bis(2-ethylhexyl mercaptoacetate), dioctyltin bis(isooctyl mercaptoacetate), tin(II) acetate, tin(II) 2-ethylhexanoate (tin(II) octoate), tin(II) isononanoate (tin(II) 3,5,5-trimethylhexanoate), tin(II) neodecanoate, tin(II) ricinoleate, tin(II) oleate, zinc(II) acetate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, bismuth acetate, bismuth 2-ethylhexanoate, bismuth octoate, bismuth isononanoate, bismuth neodecanoate, potassium formate, potassium acetate, potassium 2-ethylhexanoate (potassium octoate), potassium isononanoate, potassium neodecanoate and/or potassium ricinoleate.

In the inventive production of polyurethane foams, it may be preferable to rule out the use of organometallic salts, for example of dibutyltin dilaurate.

Suitable additional metallic catalysts are generally and preferably selected such that they do not have any troublesome intrinsic odor and are essentially toxicologically safe, and such that the resulting polyurethane systems, especially polyurethane foams, have a minimum level of catalyst-related emissions.

In the inventive production of polyurethane foams, it may be preferable, according to the type of application, to use incorporable/reactive or high molecular weight catalysts. Catalysts of this kind may be selected, for example, from the group of the metal compounds, preferably from the group of the tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, and/or from the group of the nitrogen compounds, especially from the group of the low-emission amines and/or the low-emission compounds containing one or more tertiary amine groups, for example described by the amines dimethylaminoethanol, N,N-dimethyl-N′,N′-di(2-hydroxypropyl)-1,3-diaminopropane, N,N-dimethylaminopropylamine, N,N,N′-trimethyl-N-hydroxyethylbis(aminoethyl)ether, 6-dimethylaminoethyl-1-hexanol, N-(2-hydroxypropyl)imidazole, N-(3-aminopropyl)imidazole, aminopropyl-2-methylimidazole, N,N,N′-trimethylaminoethanolamine, 2-(2-(N,N-dimethylaminoethoxy)ethanol, N-(dimethyl-3-aminopropyl)urea derivatives and alkylaminooxamides, such as bis(N-(N′,N′-dimethylaminopropyl))oxamide, bis(N-(N′,N′-dimethylaminoethyl))oxamide, bis(N-(N′,N′-1midazolidinylpropyl)oxamide, bis(N-(N′,N′-diethylaminoethyl))oxamide, bis(N-(N′,N′-diethylaminopropyl)oxamide, bis(N-(N′,N′-diethylaminoethyl)oxamide, bis(N-(N′,N′-diethylimino-1-methylpropyl)oxamide, bis(N-(3-morpholinopropylyl)oxamide, and the reaction products thereof with alkylene oxides, preferably having a molar mass in the range between 160 and 500 g/mol, and compounds of the general formula:

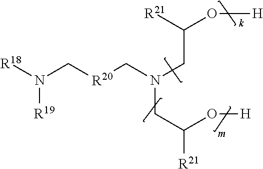

where
R18, R19=—CaH2a+i with a=1-4 for acyclic groups
R18, R19=—CbHcNd— with b=3-7, c=6-14, d=0-2 for cyclic groups
R20=CeHfO9 with e=0-4, f=0-8, g=0-2
R21=—H, —CH3, —C2H5
k, m=identically or differently 1-5.

Catalysts and/or mixtures of this kind are supplied commercially, for example, under the Jeffcat® ZF-10, Lupragen® DMEA, Lupragen® API, Toyocat® RX 20 and Toyocat® RX 21, DABCO® RP 202, DABCO® RP 204, DABCO® NE 300, DABCO® NE 310, DABCO® NE 400, DABCO® NE 500, DABCO® NE 600, DABCO® NE 1060 and DABCO® NE 2039, Niax® EF 860, Niax® EF 890, Niax® EF 700, Niax® EF 705, Niax® EF 708, Niax® EF 600, Niax® EF 602, Kosmos® 54, Kosmos® EF and Tegoamin® ZE 1 names.

Suitable use amounts of catalysts are guided by the type of catalyst and are preferably in the range from 0.005 to 10.0 pphp, more preferably in the range from 0.01 to 5.00 pphp (=parts by weight based on 100 parts by weight of polyol) or 0.10 to 10.0 pphp for potassium salts.

According to the application, it may be preferable that, in the inventive production of polyurethane foams, one or more nitrogenous and/or metallic catalysts are used. When more than one catalyst is used, the catalysts may be used in any desired mixtures with one another. It is possible here to use the catalysts individually during the foaming operation, for example in the manner of a preliminary dosage in the mixing head, and/or in the form of a premixed catalyst combination.

The expression “premixed catalyst combination”, also referred to hereinafter as catalyst combination, for the purposes of this invention especially encompasses ready-made mixtures of metallic catalysts and/or nitrogenous catalysts and/or corresponding protonated and/or quaternized nitrogenous catalysts, and optionally also further ingredients or additives, for example water, organic solvents, acids for blocking the amines, emulsifiers, surfactants, blowing agents, antioxidants, flame retardants, stabilizers and/or siloxanes, preferably polyether siloxanes, which are already present as such prior to the foaming and need not be added as individual components during the foaming operation.

According to the application, it may be preferable when the sum total of all the nitrogenous catalysts used relative to the sum total of the metallic catalysts, especially potassium, zinc and/or tin catalysts, results in a molar ratio of 1:0.05 to 0.05:1, preferably 1:0.07 to 0.07:1 and more preferably 1:0.1 to 0.1:1.

In order to prevent any reaction of the components with one another, especially reaction of nitrogenous catalysts with metallic catalysts, especially potassium, zinc and/or tin catalysts, it may be preferable to store these components separately from one another and then to feed in the isocyanate and polyol reaction mixture simultaneously or successively.

By means of the process according to the invention, a polyurethane system, preferably polyurethane foam, especially a flexible polyurethane foam, is obtainable. This polyurethane system forms a further part of the subject-matter of the invention. It is a particular feature of the polyurethane foam in question that the polyol component used for production is at least partly based on polyether polycarbonate polyol.

With the inventive polyurethane system, especially polyurethane foam, it is possible to obtain articles including or consisting of this polyurethane system, especially polyurethane foam. These articles form a further part of the subject-matter of this invention. Articles of this kind may, for example, be furniture cushioning or mattresses.

This invention further provides, in addition, a polyurethane system comprising the reaction products of polyether polycarbonate polyols, and optionally further polyol components, with one or more isocyanate components,
where the polyol used contains a total of at least 1% by weight and preferably at least 5% by weight of carbon dioxide, bound in carbonate form, and where at least 10% by weight of the polyol used is in polyether polycarbonate polyol form, % by weight based in each case on the total amount of polyol used,
   where at least one, preferably two, advantageously three and especially of all the following compounds a) to d) are present:
a) ionic surfactant A selected from those of the formula (II)

A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
b) ionic surfactant B selected from a quaternized ammonium compound,
c) a tertiary amine compound C which is not an oxazasilinane and has a molar mass of preferably at least 150 g/mol, more preferably at least 200 g/mol, and which preferably, in a concentration of 0.5% by mass in water, lowers the static surface tension of this solution to less than 40 N/m,
d) oxazasilinane D.

This invention further provides, in addition, a polyurethane system comprising the reaction products of polyether polycarbonate polyols, and optionally further polyol components, with one or more isocyanate components,
where the polyol used contains a total of at least 1% by weight and preferably at least 5% by weight of carbon dioxide, bound in carbonate form, and where at least 10% by weight of the polyol used is in polyether polycarbonate polyol form, % by weight based in each case on the total amount of polyol used,
   and comprising an additive composition containing
a) at least one ionic surfactant A selected from those of the formula (II)

A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
   and/or
b) at least one ionic surfactant B selected from a quaternized ammonium compound,
   and also
c) at least one tertiary amine compound C which is not an oxazasilinane and has a molar mass of preferably at least 150 g/mol, more preferably at least 200 g/mol, and which preferably, in a concentration of 0.5% by mass in water, lowers the static surface tension of this solution to less than 40 N/m,
   and/or, preferably and,
d) at least one oxazasilinane D.

This invention further provides, in addition, a composition suitable for production of polyurethane foams, comprising a mixture of polyol and an additive composition, as described above, wherein
i) the polyol used contains a total of at least 1% by weight, preferably at least 5% by weight, more preferably at least 10% by weight and most preferably 15% to 50% by weight of carbon dioxide, bound in carbonate form, and
ii) at least 10% by weight, advantageously at least 20% by weight, further advantageously at least 30% by weight, preferably at least 50% by weight and especially at least 75% by weight of the polyol used is in polyether polycarbonate polyol form, % by weight based in each case on the total amount of polyol used.

Such a composition according to the invention may especially contain only the additive composition and the polyether polycarbonate polyol. The additive composition is directly soluble in the polyether polycarbonate polyol. More particularly, this composition may contain 0% to 90% by weight, preferably 10% to 80% by weight, more preferably 20% to 70% by weight, based on the overall additive composition, of one or more inorganic or organic solvents, preferably selected from water, alcohols, especially polyether monools or polyether polyols, preferably consisting of H-functional starter substances onto which have been added, by means of alkoxylation, alkylene oxides (epoxides) having 2-24 carbon atoms, preferably ethylene oxide and/or propylene oxide, and which have a molecular weight of preferably 200-8000 g/mol, more preferably of 300-5000 g/mol, especially preferably of 500-1000 g/mol, and a PO content of preferably 10%-100% by weight, preferably of 50%-100% by weight, and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin.

The notion of composition in this sense also encompasses multicomponent compositions wherein two or more components have to be mixed to produce a chemical reaction leading to polyurethane system production, especially polyurethane foam production. The notion of composition encompasses in particular the mixture (mix) of at least one urethane and/or isocyanate catalyst, at least one blowing agent, at least one isocyanate component and at least one polyol component, where, based on the total amount of polyol,
i) the polyol used contains a total of at least 1% by weight, preferably at least 5% by weight, of carbon dioxide, bound in carbonate form, and
ii) at least 10% by weight of the polyol used is in polyether polycarbonate polyol form, % by weight based in each case on the total amount of polyol used.

A preferred composition according to the invention for production of a polyurethane system, especially of polyurethane foam, may contain polyol in amounts of 25% to 80% by weight, water in amounts of 1% to 5% by weight, catalyst in amounts of 0.05% to 1% by weight, physical blowing agent in amounts of 0% to 25% by weight (e.g. 0.1% to 25% by weight), stabilizers (for example Si-containing and non-Si-containing, especially Si-containing and non-Si-containing organic stabilizers and surfactants) in amounts of 0.1% to 5% by weight, isocyanate in amounts of 20% to 50% by weight and the additive composition for use in accordance with the invention in amounts of 0.001% to 10% by weight, preferably 0.1% to 5% by weight, where, based on the total amount of polyol, at least 10% by weight, advantageously at least 20% by weight, further advantageously at least 30% by weight, preferably at least 50% by weight and especially at least 75% by weight of polyether polycarbonate polyol is present, where the polyol has a total content of carbonate groups (calculated as CO₂) of at least 1% by weight, preferably of at least 5% by weight, more preferably of at least 10% by weight and most preferably of 15% to 50% by weight.

For preferred embodiments of these abovementioned compositions, reference is made explicitly to the preceding description.

A further subject of the present invention is the use of an additive composition containing
a) at least one ionic surfactant A selected from those of the formula (II)

A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
   and/or
b) at least one ionic surfactant B selected from a quaternized ammonium compound,
   and also
c) at least one tertiary amine compound C which is not an oxazasilinane and has a molar mass of preferably at least 150 g/mol, more preferably at least 200 g/mol, and which preferably, in a concentration of 0.5% by mass in water, lowers the static surface tension of this solution to less than 40 N/m,
   and/or, preferably and,
d) at least one oxazasilinane D,
   for production of polyurethane foams by reacting one or more polyol components with one or more isocyanate components,
where
   i) the polyol used contains a total of at least 1% by weight, preferably at least 5% by weight, of carbon dioxide, bound in carbonate form, and
   ii) at least 10% by weight of the polyol used is in polyether polycarbonate polyol form, % by weight based in each case on the total amount of polyol used.

At the same time, in a preferred embodiment, the additive composition for use in accordance with the invention contains 0% to 90% by weight, preferably 10% to 80% by weight, more preferably 20% to 70% by weight, based on the overall additive composition, of one or more inorganic or organic solvents, preferably selected from water, alcohols, especially polyether monools or polyether polyols, preferably consisting of H-functional starter substances onto which have been added, by means of alkoxylation, alkylene oxides (epoxides) having 2-24 carbon atoms, preferably ethylene oxide and/or propylene oxide, and which have a molecular weight of preferably 200-8000 g/mol, more preferably of 300-5000 g/mol, especially preferably of 500-1000 g/mol, and a PO content of preferably 10%-100% by weight, preferably of 50%-100% by weight, and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin.

For preferred embodiments of this aforementioned use, reference is made explicitly to the preceding description.

The invention further provides the use of the polyurethane systems obtainable in accordance with the invention as refrigerator insulation, insulation panel, sandwich element, pipe insulation, spray foam, 1- and 1.5-component can foam, wood imitation, modelling foam, packaging foam, mattress, furniture cushioning, material in vehicle interiors, automotive seat cushioning, headrest, dashboard, automotive interior, automotive roof liner, sound absorption material, steering wheel, shoe sole, carpet backing foam, filter foam, sealing foam, sealant and adhesive or for producing corresponding products, in particular as material in motor vehicle interiors.

The subject-matter of the present invention is elucidated in detail hereinafter with reference to examples, without any intention that the subject-matter of the invention be restricted to these illustrative embodiments.

### EXAMPLES

### Production of the Polyurethane Foams

For production of each of the polyurethane foams, 400 g of polyol were used; the other formulation constituents were adjusted correspondingly. In this arithmetic conversion, 1.0 part of a component meant 1 g of this substance per 100 g of polyol, for example.

For foaming, the polyol, water, catalyst (amine(s) and/or the tin compound), stabilizer and additive composition according to the invention were mixed well by stirring. After the isocyanate had been added, the mixture was stirred with a stirrer at 3000 rpm for 7 sec and the mixture was cast in a paper-lined wooden box (27 cm×27 cm base). Resultant flexible polyurethane foams were subjected to the performance tests described below.

Three recipes were used to demonstrate the present invention for foaming operations for flexible polyurethane foams. All three recipes are water-blown and free-rise (foam can rise unhindered; not moulded foams). The amount of water was chosen as 4.0 parts per 100 parts polyol mixture. On the basis of this amount of water, a density of about 25 kg/m³ can be expected. Thus, the formulation, in terms of density and amount of water, is typical of flexible polyurethane foam qualities currently used in industry for upholstery or mattress applications. According to Recipe 2 in Table 2, based on 4.0 parts water, flexible slabstock polyurethane foams were produced using a polyether polycarbonate polyol, optionally with addition of a conventional polyol, a conventional stabilizer (TEGOSTAB® BF 2370, Evonik Industries AG) and different amounts of additive according to the invention. According to Recipe 3 in Table 3, based on 4.0 parts water, flexible slabstock polyurethane foams were produced using a polyol based on a polyether polycarbonate prepolymer, a conventional stabilizer (TEGOSTAB® BF 2370, Evonik Industries AG) and different amounts of additive according to the invention. The resulting foams were compared with one another in terms of their characteristics in the foaming operation and their physical properties. Reference foams used were firstly a flexible polyurethane foam which was produced from 100% standard polyol (of petrochemical origin) (Table 1, Recipe 1) and secondly flexible polyurethane foams corresponding to Table 2 and Table 3 without addition of the additive according to the invention.

Reference foams which did not include any polyol based on polyether polycarbonates were produced as per the recipe specified in Table 1:

TABLE 1
Recipe 1 for the reference foam made from purely mineral
oil-based polyol (figures in parts by mass)

| | | |
|---|---|---|
| 100 | parts | Polyol, Voranol ® CP 3322 (Dow Chemical)*¹ |
| 4.0 | parts | Water |
| 0.8 | part | TEGOSTAB ® BF 2370 stabilizer (Evonik Industries AG) |
| 0.15 | part | Amine catalyst* |
| 0.18 | part | KOSMOS ® 29 (tin octoate, Evonik Industries AG) |
| 49.7 | parts | Desmodur ® T 80 (tolylene diisocyanate T80) |

| | |
|---|---|
| Index <108> | (80% 2,4 isomer, 20% 2,6 isomer) (Bayer Material |
| | Science AG) |

*optionally: TEGOAMIN ® 33 (Evonik Industries AG), TEGOAMIN ® B75 (Evonik Industries AG), TEGOAMIN ® SMP (Evonik Industries AG) or TEGOAMIN ® DMEA (Evonik Industries AG), TEGOAMIN ® ZE 3 (Evonik Industries AG).
*¹= Voranol ® CP 3322, available from Dow Chemical; this is a polyether triol having OH number 47.

The polyurethane foams which include a polyol based on polyether polycarbonates were produced as per the recipe specified in Table 2.

TABLE 2
Recipe 2 comprising polyether polycarbonate
polyol (figures in parts by mass)

| 100 | | parts | Polyol*² or polyol mixture*³ each with 14% by weight |
|---|---|---|---|
| | | | of CO₂, bound in carbonate form, % by weight based on |
| | | | the total amount of polyol used |
| 4.0 | | parts | Total water |
| 0.8 | | part | TEGOSTAB ® BF 2370 stabilizer (Evonik Industries AG) |
| 0.15 | | part | Amine catalyst* |
| 0.18 | | part | KOSMOS ® 29 (tin octoate, Evonik Industries AG) |
| a) | 0 | part | Inventive additive |
| b) | 1.5 | parts | |

| | | |
|---|---|---|
| 49.7 | parts | Desmodur ® T 80 (tolylene diisocyanate T80) |

| | |
|---|---|
| Index <108> | (80% 2,4 isomer, 20% 2,6 isomer) (Bayer Material |
| | Science AG) |

*optionally: TEGOAMIN ® 33 (Evonik Industries AG), TEGOAMIN ® B75 (Evonik Industries AG), TEGOAMIN ® SMP (Evonik Industries AG) or TEGOAMIN ® DMEA (Evonik Industries AG), TEGOAMIN ® ZE 3 (Evonik Industries AG).
*²Polyol prepared according to WO 2008/058913 based on Example 2.
*³= Polyol mixtures are obtained by blending Polyol 211-10 from Novomer (polyether carbonate polyol, MW = 880, OH number = 127, CO₂ content = 43% by weight) with Voranol ® CP 3322 from Dow Chemical.

The foams which include a polyol based on a polyether polycarbonate prepolymer were produced as per the recipe specified in Table 3.

TABLE 3
Recipe 3 comprising polyether polycarbonate
prepolymer (figures in parts by mass)

| 100 | | parts | Prepolymer containing 14% by weight of CO_{2*4}, bound in |
|---|---|---|---|
| | | | carbonate form, % by weight based on the total amount of |
| | | | polyol used |
| 4.0 | | parts | Water |
| 0.8 | | part | TEGOSTAB ® BF 2370 stabilizer (Evonik Industries AG) |
| 0.15 | | part | Amine catalyst* |
| 0.18 | | part | KOSMOS ® 29 (tin octoate, Evonik Industries AG) |
| a) | 0 | part | Inventive additive |
| b) | 1.5 | parts | |

| | | |
|---|---|---|
| 49.7 | parts | Desmodur ® T 80 (tolylene diisocyanate T80) |

| | |
|---|---|
| Index <108> | (80% 2,4 isomer, 20% 2,6 isomer) (Bayer Material |
| | Science AG) |

*optionally: TEGOAMIN ® 33 (Evonik Industries AG), TEGOAMIN ® B75 (Evonik Industries AG), TEGOAMIN ® SMP (Evonik Industries AG) or TEGOAMIN ® DMEA (Evonik Industries AG), TEGOAMIN ® ZE 3 (Evonik Industries AG).
*₄= Prepolymer 14% CO₂, prepared from Voranol ® CP 3322, available from Dow Chemical, and Polyol 211-10 from Novomer by reaction with two parts tolylene diisocyanate T80 using 0.06 part Kosmos EF (Sn catalyst from Evonik Industries AG) as catalyst (reaction conditions: 100° C., 1 h).

The inventive additive used in each case included the following components:
Surfactant A: Rewopol B 2003 (anionic sulphonate surfactant, Evonik Industries AG)
Surfactant B: Rewoquat W 3690 (quaternized ammonium compound, Evonik Industries AG)
Tertiary amine C: Tego Amid D 5040, static surface tension at 0.5% strength in water: 27.7 mN/m, (fatty cocoamide amine, Evonik Industries AG)
Oxazasilinane D: 2,2,4-trimethyl-1,4,2-oxazasilinane (Apollo Scientific Ltd.)

### Performance Tests

The foams produced were rated on the basis of the following physical properties:
a) Foam settling after the end of the rise phase (=fall-back):
   The fall-back, or the further rise, is found from the difference in the foam height after direct blow-off and after 3 minutes after foam blow-off. The foam height is measured at the maximum in the middle of the foam crest by means of a needle secured to a centimeter scale. A negative value here describes the settling of the foam after blow-off; a positive value correspondingly describes the further rise of the foam.
b) Foam height
   Foam height is the height of the freely risen foam formed after 3 minutes. Foam height is reported in centimeters (cm).
c) Rise time
   The period of time between the end of mixing of the reaction components and the blow-off of the polyurethane foam.
d) Density
   The determination is effected as described in DIN EN ISO 845:2009-10 by measuring the apparent density. Density is reported in kg/m³.
e) Air permeability
   The air permeability of the foam was determined in accordance with DIN EN ISO 4638:1993-07 by a dynamic pressure measurement on the foam. The dynamic pressure measured was reported in mm water column, with the lower dynamic pressure values then characterizing the more open foam. The values were measured in the range from 0 to 300 mm.
   The dynamic pressure was measured by means of an apparatus comprising a nitrogen source, a reducing valve with manometer, a screw-thread flow regulator, a wash bottle, a flow meter, a T-piece, a nozzle head and a scaled glass tube filled with water. The applicator nozzle has an edge length of 100×100 mm, a weight of 800 g, a clear width of 5 mm for the outlet hole, a clear width of 20 mm for the lower applicator ring and an outer diameter of 30 mm for the lower applicator ring.
   The measurement is effected by adjusting the nitrogen supply pressure to 1 bar with the reducing valve and adjusting the flow rate to 480 l/h. The amount of water in the scaled glass tube is adjusted such that no pressure differential is built up and none can be read off. For the analysis of the test specimen having dimensions of 250×250×50 mm, the nozzle head is placed onto the corners of the test specimen, flush with the edges, and once onto the (estimated) middle of the test specimen (in each case on the side with the greatest surface area). The result is read off when a constant dynamic pressure has been established.
   Evaluation is effected by forming the average of the five measurements obtained.
f) Number of cells per cm (cell count): This is determined visually on a cut surface (measured to DIN EN 15702).
g) Indentation hardness CLD, 40% to DIN EN ISO 3386-1:1997+A1:2010. The measured values are reported in kilopascals (kPa).
h) Tensile strength and elongation at break to DIN EN ISO 1798:2008.

### Results of the Foaming Operations:

The results of the performance tests for the various recipes and the additives used are shown in Tables 4 to 6.

TABLE 4
Foaming results with use of TEGOAMIN ®
33 (Evonik Industries AG) as amine catalyst

| Experiment number | 1 | 2 | 3 | 4 | 5 | 6 | 7 |
|---|---|---|---|---|---|---|---|
| Recipe | 1 | 2a) | 2b) | 2a) | 2b) | 3a) | 3b) |
| Prepolymer 14% CO₂ | | | | | | 100 | 100 |
| Polyol/polyol mixture | | 100*² | 100*² | 100*³ | 100*³ | | |
| 14% CO₂ | | | | | | | |
| Polyol 0% CO₂ | 100 | | | | | | |
| Amine catalyst | TA 33 | TA 33 | TA 33 | TA 33 | TA 33 | TA 33 | TA 33 |
| Rise time | 104 | 128 | 110 | 115 | 108 | 126 | 89 |
| Height | 30.4 | 27.9 | 29.8 | 28.0 | 29.9 | 27 | 30.8 |
| Blow-off | yes | yes | yes | yes | yes | yes | yes |
| Fall-back | −0.2 | −0.8 | −0.4 | −0.9 | −0.4 | −0.3 | −0.3 |
| Density | 24.5 | 25.3 | 25.2 | 25.5 | 25.0 | 23.9 | 22.9 |
| Porosity | 6 | 15 | 18 | 17 | 28 | 23 | 38 |
| Compression load | 3 | 3.8 | 3.7 | 3.4 | 3.4 | 4.5 | 4.4 |
| deflection CLD, 40% | | | | | | | |
| Cell count | 17 | 16 | 17 | 17 | 15-16 | 16 | 18 |
| Elongation at break (%) | 272 | 201 | 263 | 213 | 256 | 95 | 144 |
| Tensile strength (kPa) | 94 | 69 | 87 | 72 | 88 | 66 | 79 |

*²Polyol prepared according to WO 2008/058913 based on Example 2.
*³= Polyol mixtures are obtained by blending Polyol 211-10 from Novomer (polyether carbonate polyol, MW = 880, OH number = 127, CO₂ content = 43% by weight) with Voranol ® CP 3322 from Dow Chemical.

Experiment numbers 3, 5 and 7 in Table 4 are in accordance with the invention. In the case of the test series with TEGOAMIN® 33 (Evonik Industries AG) as amine catalyst (Table 4), it was found that flexible PUR foams produced through use of a carbon dioxide-containing polyol, as compared with foams based on conventional polyol (reference foam, experiment number 1) without use of the inventive additive, had prolonged rise times and lower gas yields (experiment numbers 2, 4 and 6). Through the addition of 1.5 parts of the inventive additive, it was possible to significantly reduce the rise time and increase the gas yields to a level with the reference foam (experiment numbers 3, 5 and 7). It was likewise possible to again distinctly increase the tensile strength and elongation at break, which was greatly reduced through the use of CO₂-containing polyol (experiment numbers 2, 4 and 6, reference foam experiment number 1), through the addition of 1.5 parts of the inventive additive (experiment numbers 3, 5 and 7). In addition, it was found that the use of CO₂-containing polyol in the form of a prepolymer led to foams having greatly increased compression load deflection (experiment numbers 6 and 7).

The results shown in Tables 5 and 6 (experiment numbers 10, 12, 15, 17, 20, 22, 25 and 27 are in accordance with the invention) indicate that polyether polycarbonate-based foams which have been produced with amine catalysts other than TEGOAMIN® 33 (Evonik Industries AG) and without use of the inventive additive also had a distinctly prolonged rise time and a lower gas yield compared to flexible PUR foams based on conventional polyol (experiment numbers 9, 14, 19 and 24 in the case of CO₂-containing polyol and experiment numbers 11, 16, 21 and 26 in the case of CO₂-containing polyol which was in the form of a prepolymer; reference foams experiment numbers 8, 13, 18 and 23). A deterioration in tensile strength and elongation at break was likewise found. Through the use of 1.5 parts of the inventive additive, even in the case of foaming operations that were based on the use of TEGOAMIN® B75 (Evonik Industries AG), TEGOAMIN® SMP (Evonik Industries AG), TEGOAMIN® DMEA (Evonik Industries AG) or TEGOAMIN® ZE 3 (Evonik Industries AG) as amine catalysts, it was possible to improve both the rise time and the gas yield (experiment numbers 10, 12, 15, 17, 20, 22, 25 and 27). It was also possible again to distinctly enhance tensile strength and elongation at break through the use of the inventive additive. It is likewise apparent in the examples from Tables 5 and 6 that foams produced through use of a CO₂-based prepolymer exhibit elevated compression load deflection (experiment numbers 11 and 12, 16 and 17, 21 and 22, 26 and 27).

TABLE 5
Foaming results with use of TEGOAMIN ® B75 (Evonik Industries AG) and
TEGOAMIN ® SMP (Evonik Industries AG) as amine catalyst

| Experiment number | 8 | 9 | 10 | 11 | 12 | 13 | 14 | 15 | 16 | 17 |
|---|---|---|---|---|---|---|---|---|---|---|
| Recipe | 1 | 2a) | 2b) | 3a) | 3b) | 1 | 2a) | 2b) | 3a) | 3b) |
| Prepolymer*⁴ 14% CO₂ | | | | 100 | 100 | | | | 100 | 100 |
| Polyol mixture*³ 14% CO₂ | | 100 | 100 | | | | 100 | 100 | | |
| Polyol 0% CO₂ | 100 | | | | | 100 | | | | |
| Amine catalyst | B 75 | B 75 | B 75 | B 75 | B 75 | SMP | SMP | SMP | SMP | SMP |
| Rise time | 98 | 110 | 85 | 107 | 87 | 106 | 120 | 103 | 139 | 94 |
| Height | 30.6 | 29.5 | 32.7 | 29.4 | 30.4 | 30.2 | 29.0 | 31.4 | 28.8 | 30.5 |
| Blow-off | yes | yes | yes | yes | yes | yes | yes | yes | yes | yes |
| Fall-back | −0.2 | −0.6 | −0.8 | 0 | −0.2 | 0 | −0.6 | −0.8 | 0 | 0 |
| Density | 23.3 | 21.6 | 21.7 | 22.8 | 21.7 | 22.4 | 21.0 | 21.6 | 22.8 | 22.4 |
| Porosity | 12 | 12 | 15 | 61 | 90 | 30 | 12 | 7 | 27 | 52 |
| Compression load | 3.2 | 3.7 | 3.5 | 4.6 | 4.2 | 3.4 | 3 | 3.1 | 3.9 | 4.2 |
| deflection CLD, 40% | | | | | | | | | | |
| Cell count | 15 | 15 | 18-19 | 15 | 15 | 15-16 | 16 | 16 | 15-16 | 14 |
| Elongation at break (%) | 281 | 181 | 244 | 137 | 164 | 311 | 207 | 248 | 172 | 235 |
| Tensile strength (kPa) | 78 | 58 | 72 | 62 | 76 | 79 | 63 | 71 | 68 | 75 |

*³= Polyol mixtures are obtained by blending Polyol 211-10 from Novomer (polyether carbonate polyol, MW = 880, OH number = 127, CO₂ content = 43% by weight) with Voranol ® CP 3322 from Dow Chemical.
*⁴= Prepolymer 14% CO₂, prepared from Voranol ® CP 3322, available from Dow Chemical, and Polyol 211-10 from Novomer by reaction with two parts tolylene diisocyanate T80 using 0.06 part Kosmos EF (Sn catalyst from Evonik Industries AG) as catalyst (reaction conditions: 100° C., 1 h).

TABLE 6
Foaming results with use of TEGOAMIN ® DMEA (Evonik Industries AG) and
TEGOAMIN ® ZE 3 (Evonik Industries AG) as amine catalyst

| Experiment number | 18 | 19 | 20 | 21 | 22 | 23 | 24 | 25 | 26 | 27 |
|---|---|---|---|---|---|---|---|---|---|---|
| Recipe | 1 | 2a) | 2b) | 3a) | 3b) | 1 | 2a) | 2b) | 3a) | 3b) |
| Prepolymer*⁴ 14% CO₂ | | | | 100 | 100 | | | | 100 | 100 |
| Polyol mixture*³ 14% CO₂ | | 100 | 100 | | | | 100 | 100 | | |
| Polyol 0% CO₂ | 100 | | | | | 100 | | | | |
| Amine catalyst | DMEA | DMEA | DMEA | DMEA | DMEA | ZE 3 | ZE 3 | ZE 3 | ZE 3 | ZE 3 |
| Rise time | 113 | 124 | 99 | 156 | 108 | 93 | 103 | 93 | 105 | 82 |
| Height | 29.7 | 28.1 | 31.0 | 27.4 | 29.4 | 31.2 | 29.0 | 31.2 | 29.0 | 29.9 |
| Blow-off | yes | yes | yes | yes | yes | yes | yes | yes | yes | yes |
| Fall-back | 0 | −0.7 | −0.6 | 0 | (+)0.1 | −0.4 | −0.8 | −0.8 | 0 | −0.2 |
| Density | 23.2 | 21.4 | 21.8 | 22.9 | 22.5 | 23.1 | 21.3 | 21.3 | 22.2 | 22.5 |
| Porosity | 13 | 14 | 12 | 37 | 60 | 10 | 10 | 10 | 42 | 51 |
| Compression load | 3.2 | 3 | 2.9 | 4.2 | 3.7 | 2.9 | 2.8 | 2.8 | 3.9 | 3.7 |
| deflection CLD, 40% | | | | | | | | | | |
| Cell count | 15 | 14 | 16 | 13-14 | 14 | 16 | 14 | 14-15 | 14 | 16-17 |
| Elongation at break (%) | 301 | 161 | 222 | 172 | 234 | 323 | 167 | 254 | 182 | 230 |
| Tensile strength (kPa) | 96 | 59 | 77 | 68 | 82 | 89 | 55 | 72 | 63 | 69 |

*³= Polyol mixtures are obtained by blending Polyol 211-10 from Novomer (polyether carbonate polyol, MW = 880, OH number = 127, CO₂ content = 43% by weight) with Voranol ® CP 3322 from Dow Chemical.
*⁴= Prepolymer 14% CO₂, prepared from Voranol ® CP 3322, available from Dow Chemical, and Polyol 211-10 from Novomer by reaction with two parts tolylene diisocyanate T80 using 0.06 part Kosmos EF (Sn catalyst from Evonik Industries AG) as catalyst (reaction conditions: 100° C., 1 h).

1. A process for producing polyurethane systems, especially polyurethane foams, by reacting one or more polyol components with one or more isocyanate components,
where
i) the polyol used contains a total of at least 1% by weight, of carbon dioxide, bound in carbonate form, and
ii) at least 10% by weight of the polyol used is in polyether polycarbonate polyol form, % by weight based in each case on the total amount of polyol used,
in the presence of an additive, additives employed being at least one, preferably two, advantageously three and especially all of the following compounds a) to d):
a) ionic surfactant A selected from those of the formula (II)
A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially preferably a potassium or sodium cation,
b) ionic surfactant B selected from a quaternized ammonium compound,
c) a tertiary amine compound C which is not an oxazasilinane and has a molar mass of preferably at least 150 g/mol,
d) oxazasilinane D.

2. The process according to claim 1, wherein the additive used contains 0% to 90% by weight based on the overall additive composition, of one or more inorganic or organic solvents by means of alkoxylation, alkylene oxides (epoxides) having 2-24 carbon atoms and which have a molecular weight of preferably 200-8000 g/mol and a PO content of preferably 10%-100% by weight and polyester monools or polyester polyols having a molecular weight preferably in the range from 200 to 4500 g/mol, glycols, alkoxylates, carbonates, ethers, esters, branched or linear aliphatic or aromatic hydrocarbons and/or oils of synthetic and/or natural origin.

3. The process for producing polyurethane systems according to claim 1,
wherein the additive used is an additive composition comprising
a) at least one ionic surfactant A selected from those of the formula (II)
A⁻M⁺ (II)
with A⁻=anion selected from the group comprising alkyl- and arylsulphates, polyethersulphates and -sulphonates, sulphonates, alkyl- and arylsulphonates, alkyl- and arylcarboxylates, saccharinates and polyetherphosphates, and M⁺=cation which is not an ammonium cation and is preferably a metal cation, more preferably an alkali metal cation and especially prcfcrably a potassium or sodium cation,
and/or
b) at least one ionic surfactant B selected from a quaternized ammonium compound,
and additionally
c) at least one tertiary amine compound C which is not an oxazasilinane and has a molar mass of at least 150 g/mol,
and/or, preferably and,
d) at least one oxazasilinane D.

4. The process according to claim 1, wherein at least 20% by weight of the polyol used is in polyether polycarbonate polyol form, % by weight based in each case on the total amount of polyol used.

5. The process according to claim 1, wherein the polyol has a total content of carbonate groups (calculated as CO₂) of at least 1% by weight based on the total amount of polyol used.

6. The process according to claim 1, wherein the polyether polycarbonate polyol has a number-average molecular weight of 500 to 20,000 measured by means of GPC (gel permeation chromatography).

7. The process according to claim 1, wherein the additive composition comprises at least one oxazasilinane D, especially 2,2,4-trimethyl-1,4,2-oxazasilinane of formula (V)

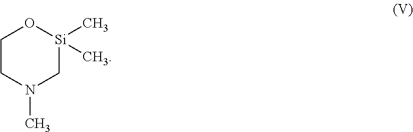

8. The process according to claim 1, wherein the additive composition includes, as ionic surfactant B, at least one imidazolium compound of the formula (IIIh) 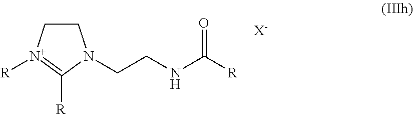
with R=identical or different, saturated or unsaturated, optionally alkoxylated hydrocarbyl radicals having 1 to 30 carbon atoms,
X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion.

9. The process according to claim 1, wherein both an ionic surfactant B and an oxazasilinane D are present in the additive composition.

10. The process according to claim 1, wherein the mass ratio of the sum total of all the amines C to the sum total of all the oxazasilinanes D is from 500:1 to 1:1.

11. The process according to claim 1, wherein the amount of additive composition is chosen such that 0.001 to 10 parts by weight, of the additive composition are used per 100 parts by weight of the total amount of polyol used.

12. The process according to claim 1, wherein the additive composition comprises at least 3 components:
(i) as tertiary amine compound C having a molar mass of preferably at least 150 g/mol, more preferably of at least 200 g/mol, at least one compound of the formula (IV) 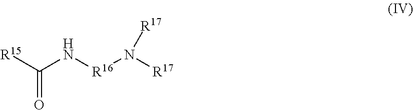
where
R¹⁵=saturated or unsaturated hydrocarbyl radicals having 5 to 30 and preferably 8 to 20 carbon atoms,
R¹⁶=divalent alkyl radical having 2 or 3 carbon atoms,
R¹⁷=identical or different, preferably identical, alkyl radicals having 1 to 3 carbon atoms, preferably methyl radicals,
especially dimethylaminopropylcocoamide,
(ii) at least one ionic surfactant B selected from a quaternized ammonium compound, preferably an imidazolium compound, especially an imidazolium compound of the formula (IIIh), 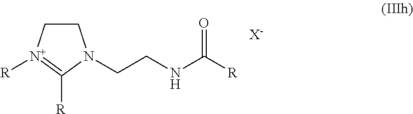
with R=identical or different, saturated or unsaturated, optionally alkoxylated hydrocarbyl radicals having 1 to 30 carbon atoms,
X⁻=anion from the group of the halides, nitrates, sulphates, hydrogensulphates, alkyl- and arylsulphates, polyethersulphates and -sulphonates, sulphonates, alkyl- and arylsulphonates, alkyl- and arylcarboxylates, saccharinates, polyetherphosphates and phosphates, preferably chloride, phosphate or methylsulphate anion, especially methylsulphate anion.
(iii) at least one oxazasilinane D, especially 2,2,4-trimethyl-1,4,2-oxazasilinane of formula (V) 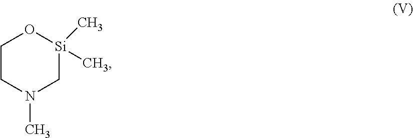
the polyol component used being a polyol mixture comprising at least 10% by weight, advantageously at least 20% by weight of polyether polycarbonate polyol based on the total amount of polyol used.

13. A polyurethane system, especially polyurethane foam, obtainable by a process according to claim 1.

14. A composition suitable for production of polyurethane systems, especially polyurethane foams, wherein it comprises a mixture of polyol and an additive composition as defined in claim 1,
where
i) the polyol used contains a total of at least 1% by weight of carbon dioxide, bound in carbonate form, and
ii) at least 10% by weight of the polyol used is in polyether polycarbonate polyol form, % by weight based in each case on the total amount of polyol used.
